(19) United States
(12) Patent Application Publication
(10) Pub. No.: US 2007/0039786 A1
(43) Pub. Date: Feb. 22, 2007

(54) ARTICULATED CASTOR BRAKING SYSTEM

(76) Inventor: Douglas G. Willis, Colby, KS (US)

Correspondence Address: HOVEY WILLIAMS LLP, 2405 GRAND BLVD., SUITE 400, KANSAS CITY, MO, 64108, US

(21) Appl. No.: 11/164,578

(22) Filed: Nov. 29, 2005

Related U.S. Application Data
(63) Continuation-in-part of application No. 10/886,369, filed on Jul. 6, 2004, now Pat. No. 7,146,683.

(51) Int. Cl. B60B 33/00

(52) U.S. Cl. 188/1.12; 188/19

(57) ABSTRACT

A carriage incorporating an articulated caster braking system is disclosed. The carriage includes a frame with a base section that pivots relative to the rest of the frame and pivotally attaches to caster wheels. The base section provides a walking-beam suspension for the frame by pivoting at a point between a pair of the caster wheels. The carriage also includes a brake assembly that is attached to the frame and restricts carriage movement by directly engaging the ground. The brake assembly includes a brake arm that engages the ground and redundant actuators for shifting the brake arm between engaged and disengaged positions.

### RELATED APPLICATION

This application is a continuation-in-part of U.S. patent application Ser. No. 10/886,369, filed Jul. 6, 2004, entitled ARTICULATED CASTER, which is hereby incorporated by reference herein.

### BACKGROUND OF THE INVENTION

1. Field of the Invention

The present invention relates generally to casters and wheeled load-supporting carts. More specifically, the present invention concerns a cart or carriage that includes a brake.

2. Discussion of Prior Art

Brakes for individual caster wheels are known in the art. These brakes generally provide a braking mechanism that frictionally engages the wheel. Such friction brakes are mounted on the caster wheel axle or on the caster wheel housing. Wheeled carts with brakes are also known in the art. For example, some prior art carts employ frictional brakes similar to those just noted. Also, wheeled structures with brakes that directly engage a ground surface are known in the art.

Frictional wheel brakes are problematic and suffer from certain limitations. Where many casters are used in a wheeled assembly, the user often must choose either to set all of the brakes, which is a slow process, or set some of the brakes and risk accidental and unsafe movement of the assembly. Where the surface is slick or uneven, some of the casters may not properly engage the surface to restrict movement of the assembly. Accordingly, there is a need for an improved braking system that does not suffer from these problems and limitations. Furthermore, there are no known brake systems for articulated casters or carts having articulated casters.

### SUMMARY OF THE INVENTION

A first aspect of the present invention concerns a carriage for supporting a load above a surface. The carriage broadly includes a frame, a plurality of wheels, and a brake. The frame includes a load-supporting section and a pivotal section. The sections are pivotally coupled along a substantially horizontal axis. The plurality of wheels includes a pair of wheels attached to the base section for supporting at least a portion of the load. The pair of wheels is spaced oppositely from the axis so that the pivotal section operates as a walking beam. The brake is shiftable into an engaged condition wherein the brake engages the surface for restricting carriage movement. The brake is mounted to the frame and spaced between the pair of wheels so that the engaged brake at least partly supports the load.

A second aspect of the present invention concerns a carriage for supporting a load above a surface. The carriage broadly includes a frame configured to support the load, a plurality of caster wheels, and a brake. The plurality of caster wheels are pivotally attached to the frame for providing rolling movement over the surface. The brake is operable to engage the surface in an engaged condition and thereby restrict movement of the carriage across the surface when in the engaged condition. The brake includes a shiftable brake arm shiftably attached to the frame for movement into and out of a braking position corresponding to the engaged condition of the brake. The brake further includes first and second brake control levers, each of which independently controls shifting of the brake arm into the braking position, wherein either control lever can be used to control engagement of the brake.

A third aspect of the present invention concerns a caster-supported carriage for supporting a load above a surface. The carriage broadly includes a load-supporting frame section, a caster assembly, and a brake. The caster assembly includes a base frame section and at least three spaced apart caster wheels that cooperatively support the base frame section so that the caster assembly is self-supporting. The frame sections are pivotally interconnected at a joint that provides relative movement about at least two substantially orthogonal pivot axes. The brake is mounted to the load-supporting frame section. The brake is configured to engage the surface and thereby restrict carriage movement.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary upper perspective view of an articulated caster constructed in accordance with a preferred embodiment of the present invention;

FIG. 2 is a fragmentary lower perspective view of the articulated caster shown in FIG. 1;

FIG. 3a is a fragmentary perspective view of the articulated caster shown in FIGS. 1 and 2, particularly showing a brake disengaged with a brake arm in a retracted position;

FIG. 3b is a fragmentary perspective view of the articulated caster similar to FIG. 3a, but showing the brake lever being shifted downward so that the brake arm contacts the surface but prior to the brake being engaged;

FIG. 3c is a fragmentary perspective view of the articulated caster similar to FIG. 3a, but showing the brake engaged with the brake arm contacting the surface;

FIG. 3d is a fragmentary perspective view of the articulated caster similar to FIG. 3a, but showing the brake being released;

FIG. 4 is a fragmentary upper perspective view of the articulated caster shown in FIGS. 1-3, showing the brake in a disengaged position;

FIG. 5 is an upper perspective view of a carriage constructed in accordance with a second embodiment of the present invention;

FIG. 6 is a lower perspective view of the carriage shown in FIG. 5;

FIG. 7 is an enlarged fragmentary perspective view of the carriage shown in FIGS. 5 and 6, showing a disengaged brake;

FIG. 8 is an enlarged fragmentary perspective view of the carriage shown in FIGS. 5-7, showing the brake engaged;

FIG. 9 is an enlarged fragmentary cross-sectional view of the carriage shown in FIGS. 5-7, showing the position of the brake arm, a brake control lever, and an interconnecting link in the disengaged position;

FIG. 10 is an enlarged fragmentary cross-sectional view of the carriage similar to FIG. 9, but showing the position of the brake arm, the brake control lever, and the interconnecting link in the engaged position with the brake control lever shifted over-center and beyond a maximum displacement position of the brake arm;

FIG. 11 is an enlarged fragmentary cross-sectional view of the carriage similar to FIG. 10, but showing the release lever depressed so that the brake control lever is shifted over-center for disengaging the brake arm;

FIG. 12 is an enlarged fragmentary cross-sectional view of the carriage similar to FIG. 10, but showing the actuator-driven control lever shifted so that the brake is engaged;

FIG. 13 is an enlarged fragmentary cross-sectional view of the carriage similar to FIG. 12, but showing the actuator-driven control lever shifted to contact the interconnecting link that is shifted over-center for disengaging the brake;

FIG. 14 is an enlarged fragmentary cross-sectional view of the carriage similar to FIG. 13, but showing the actuator-driven control lever shifted with the interconnecting link being shifted over-center for disengaging the brake;

FIG. 15 is an enlarged fragmentary cross-sectional view of the carriage shown in FIGS. 5-7, showing a pneumatic actuator with a cylinder rod in an extended position corresponding to disengagement of the actuator;

FIG. 16 is an enlarged fragmentary cross-sectional view of the carriage similar to FIG. 15, but showing the pneumatic actuator with the cylinder rod in a retracted position corresponding to engagement of the actuator;

FIG. 17 is an upper perspective view of a carriage constructed in accordance with a third embodiment of the present invention;

FIG. 18 is a lower fragmentary perspective view of the carriage shown in FIG. 17;

FIG. 19 is a fragmentary cross-sectional perspective view of the carriage shown in FIGS. 17 and 18, showing a brake disengaged;

FIG. 20 is a fragmentary cross-sectional perspective view of the carriage similar to FIG. 19, but showing the brake engaged;

FIG. 21 is a fragmentary exploded perspective view of the brake shown in FIGS. 17-20, showing the brake disengaged;

FIG. 22 is a fragmentary perspective view of the brake shown in FIGS. 17-21, showing the brake disengaged with a rocker arm lever contacting a stop;

FIG. 23 is a fragmentary perspective view of the brake similar to FIG. 22, but showing the brake engaged;

FIG. 24 is a fragmentary cross-sectional view of the carriage shown in FIGS. 17-23, showing the brake disengaged and the corresponding position of the linkage and brake arms;

FIG. 25 is a fragmentary cross-sectional view of the carriage similar to FIG. 24, but showing the brake engaged and the corresponding position of the linkage and brake arms;

FIG. 26 is a perspective view of a telescoping brake lever shown in FIGS. 17-20, showing the lever shifted to its outermost position;

FIG. 27 is a perspective view of the telescoping brake lever similar to FIG. 26, but showing the lever shifted to a retracted position;

FIG. 28 is a cross-sectional view of the telescoping brake lever shown in FIGS. 26 and 27; and

FIG. 29 is a cross-sectional view of the telescoping brake lever taken along line 29-29 of FIG. 28.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The figures illustrate various embodiments of a carriage constructed in accordance with a preferred embodiment of the present invention. The disclosed carriage embodiments provide a stable platform for supporting relatively large loads with small caster wheels on an irregular surface. The disclosed embodiments also permit the load to be moved over that surface by the application of relatively small lateral forces. While the illustrated embodiments are primarily intended for industrial load supporting applications, the principles of the present invention are equally applicable in other personal or consumer applications (e.g., computer, instrumentation, and medical applications). Such applications may involve mobile load-carrying devices such as carts, trailers, or hand trucks.

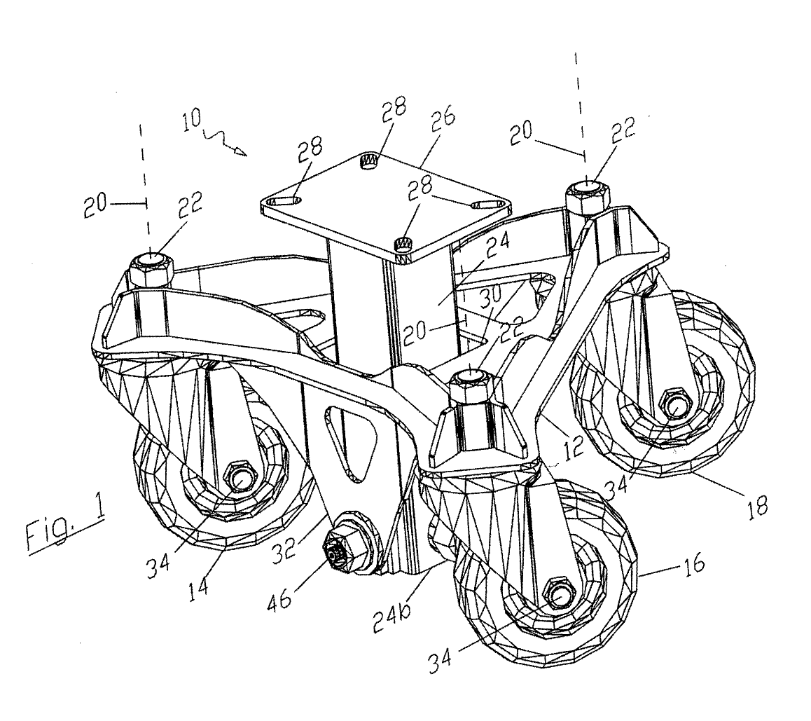

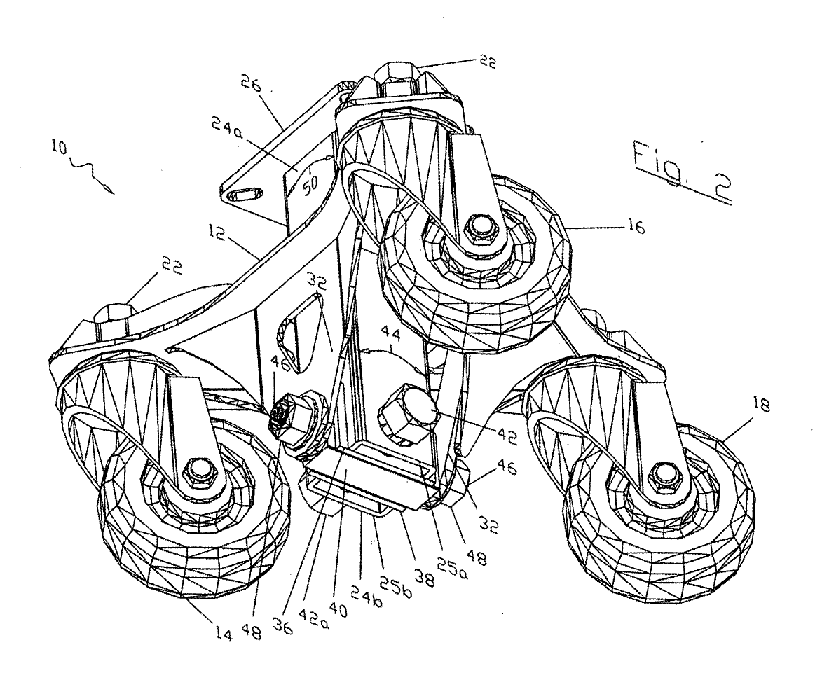

Referring to FIG. 1 and FIG. 2, an articulated caster is shown, identified in general by the reference numeral 10.

A base assembly 12 preferably includes a lead wheel 14 and two trailing wheels 16, 18. All wheels 14-18 preferably rotate about a vertical axis 20 that passes through a mounting bolt 22 of each wheel 14-20.

The two trailing wheels 16, 18 are preferably also staggered so that they are not parallel. This helps smooth movement when a surface irregularity is encountered.

A pivot arm 24 includes an upper end 24a and an opposite lower end 24b. The upper end 24a is attached to a flange plate 26. The flange plate includes bolt holes 28 and is used to attach the caster 10 to an object (not shown) that is to be supported by the caster 10.

The pivot arm 24 passes through a correspondingly shaped opening 30 in the base assembly 12. The base assembly 12 includes a pair of side members 32 that extend down on opposite sides of the opening 30 to a location that is, preferably, lower than that of an axle 34 of each of the wheels 14-18. The side members 32 are securely attached to the base assembly 12.

All load (i.e., the weight of the object) that is applied to each caster 10 is transferred through the pivot arm 24 to a lower end of both of the side members 32. This is described in greater detail hereinafter.

However, it is important to note that by transferring the load to a location within the caster 10 that is proximate or below the axles 34, as the object is moved laterally (along the surface), there is no force applied to the caster 10 above the axles 34. This provides a low effective center of gravity for the caster 10 as it supports the weight of the object, thereby making the caster 10 especially stable.

Referring now primarily to FIG. 2, the lower end 24b of the pivot arm 24 includes a first side 25a and an opposite second side 25b. A rectangular opening is provided in the lower end 24b, of the pivot arm 24 intermediate the first side 25a and the second side 25b. The rectangular opening is open at the lower end 24b, and it extends up along the longitudinal length of the pivot arm 24 for a predetermined distance.

A first side plate 36 is attached to the first side 25a, and a second side plate 38 is attached to the second side 25b. Attachment, as used anywhere herein, is by any preferred method. It can include welding, molding together as a unit, bolts and nuts, or any other method.

A pivot block 40 is inserted in the space between the first and second side plates 36, 38. The pivot block 40 can move in the space, as is described hereinbelow, yet the fit between the pivot block 40 and the side plates 36, 38 includes minimal tolerance and, therefore, minimal slack.

A first bolt 42 passes through an opening in the first side 25a, through a coincident opening in the first side plate 36, through a coincident opening through the pivot block 40, through a coincident opening in the second side plate 38, and through a coincident opening in the second side 25b. The first bolt 42 is secured in place, preferably by a lock nut 42a or other locking means.

The pivot arm 24 is adapted to pivot from side to side, as shown by arrow 44, with respect to the pivot block 40. This defines a first axis of pivoting for the pivot arm 24 with respect to the base assembly 12 (i.e., through a longitudinal axis of the first bolt 42). Obviously, the pivot arm 24 cannot pivot more than the space intermediate the pivot arm 24 and the opening 30 in the base assembly 12 allows.

The pivot block 40 includes a pair of threaded extensions (not shown) that extend from the center of the pivot block 40 and which pass through two openings provided on opposite sides of the side members 32 as low as possible. A grease fitting 46 is preferably attached to each threaded extension wherein each threaded extension includes an opening that is adapted to convey grease into the pivot block 40. If preferred, only one grease fitting 46 may be used.

A pair of lock nuts 48 cooperate with threads on the threaded extensions and are used to secure the pivot block 40 to the side members 32. The pivot block 40, therefore, acts as a second bolt to secure the pivot arm 24 to the base assembly 12 and as one which includes a longitudinal axis that is always perpendicular with respect to the first bolt 42.

Another embodiment, also preferable, is to include the grease fitting 46 in a hollow bolt (in this alternate embodiment, also as shown, the hollow bolt is identified by reference number 48), which, accordingly, shows the head of the hollow bolt 48 and where the hollow bolt 48 screws into threads that are provided in an end of the pivot block 40.

The pivot block 40 is adapted to pivot from side to side, as shown by arrow 50, with respect to the side members 32, and within the limits as afforded by the opening 30. This defines a second axis of pivoting for the pivot arm 24 (i.e., around the longitudinal center of the pivot block 40) with respect to the base assembly 12.

Accordingly, the caster 10 is adapted to pivot about two axes that are perpendicular to each other with respect to the base assembly 12. It is possible to use angles other than perpendicular for special purposes. The longitudinal axis of the first bolt 42 is in line with the normal direction (i.e., line) of travel. The longitudinal axis of the pivot block 40 (the second bolt) is preferably disposed at a 90 degree angle with respect to the normal direction of anticipated movement by the caster 10. This allows the wheels 14-18 of the caster to overcome surface irregularities with ease.

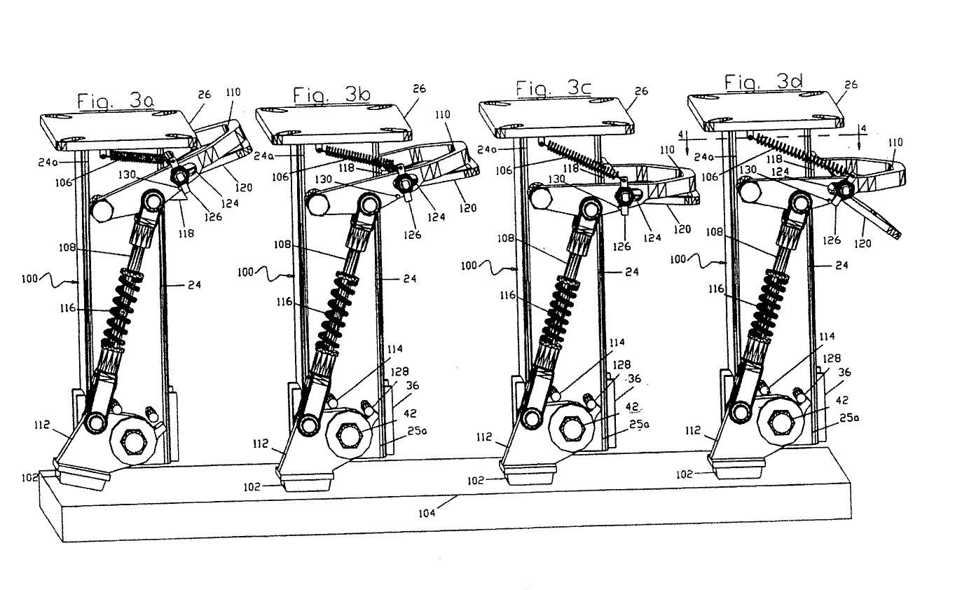

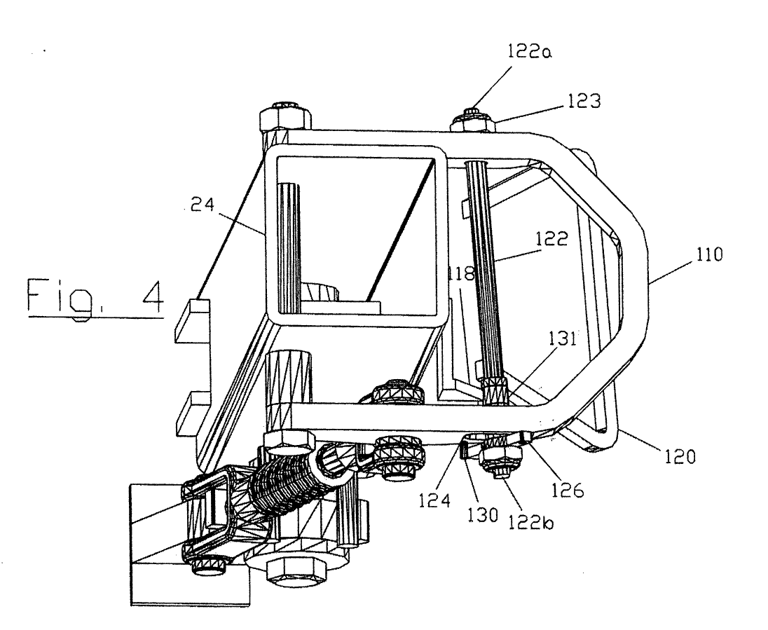

Referring now in particular also to FIGS. 3a-3d and also on occasion to FIG. 4, is shown a brake assembly, identified in general by the reference numeral 100.

FIG. 3a shows the brake assembly 100 in a first retracted position in which a brake pad 102 is elevated above a surface 104.

A return spring 106 is holding the brake assembly 100 in the first retracted position. This ensures that no braking force is applied when the brake assembly 100 is released (i.e., when it is in the first position).

A pivot rod 108 is pivotally attached at an upper end to a brake lever 110 and at an opposite end to a brake pad support member 112. The brake pad support member 112 is attached over one end of the first bolt 42, about which it is adapted to pivot.

There are of course other ways of pivotally attaching the brake pad support member 112. For example, a sleeve (not shown) may be welded to the pivot arm 24 and another bolt may be used to engage threads in the sleeve allowing the brake pad support member 112 to pivot about the other bolt or sleeve as desired. Alternatively, a pivot pin may be used as well as bushings, etc. These variations are useful in diminishing wear or improving smoothness of operation.

A first stop pin 114, attached to the pivot arm 24, prevents the brake pad support member 112 from retracting further, as urged by the return spring 106.

The pivot rod 108 preferably bears against a compression spring 116. In the first position, the compression spring 116 is somewhat relaxed because the pivot rod 108 is not supplying a force that is attempting to compress it.

A latch plate 118 is attached to one side of the pivot arm 24. The latch plate 118 includes an upper tapered surface and a flat bottom surface. A brake release lever 120 includes a shaft 122 that includes a first end 122a which passes through a hole provided in one side of the brake lever 110. A shaft nut 123 secures the shaft to the brake lever 110. The shaft 122 is adapted to rotate and tilt slightly within the holes provided.

The shaft 122 includes an opposite end 122b that passes through a slot 124 provided in an opposite side of the brake lever 110. An end rod 126 is attached to the opposite end 122b of the shaft 122. The end rod 126 retains the opposite end 122b of the shaft 122 in the slot 124.

One end of the return spring 106 is attached to one end of the end rod 126. The return spring 106 tends to urge the opposite end 122b of the shaft 122 of the brake release lever 120 to the left of the slot 124, as shown (i.e., toward the pivot arm 24). The return spring 106 also urges the brake release lever 120 toward the first position. In the first position, the shaft 122 is disposed adjacent to the left side of the slot 124 and above the latch plate 118.

As is described in greater detail hereinafter, the opposite end 122b of the shaft 122 is adapted to extend over the upper tapered surface of the latch plate 118 as it is lowered. Once the shaft 122 is below the flat bottom surface of the latch plate 118, the return spring 106 urges the opposite end 122b under the flat bottom surface, thereby retaining the shaft 122 and brake lever 110 in a second position in which a braking force is applied.

FIG. 3b shows the brake assembly 100 as a braking force is being applied. The brake lever 110 has been urged downward sufficiently so that a bottom edge of the brake pad 102 is beginning to contact the surface 104. The brake pad 102 is a replaceable wear item that is chosen for the specific application to provide an optimum coefficient of friction intermediate the brake pad 102 and the surface 104.

The opposite end 122b is extended away from the pivot arm 24 by the latch plate 118. Careful examination reveals that in FIG. 3b, the opposite end 122b of the shaft 122 is on the verge of being urged downward sufficient to clear the flat bottom surface of the latch plate 118. The return spring 106 is fully extended.

FIG. 3c shows the brake assembly 100 in the second fully engaged position. The brake lever 110 has been lowered by the user sufficient so that the shaft 122 has cleared the bottom of the latch plate 118. The return spring has urged the opposite end 122b of the shaft 122 to the left of the slot 124 and under the flat bottom surface of the latch plate 118 where the latch plate 118 now retains the brake lever 110 in the second position.

In this position, the brake pad 102 is lowered an amount sufficient to cause the lower surface of the brake pad 102 to be disposed below the surface 104. This preferably compresses the spring 116 and brake pad 102, or it may alternatively attempt to raise the object, or both. It is generally not preferred that the object be raised a greater amount above the surface 104 when the brake assembly 100 is engaged. A positive frictional engagement intermediate the pivot arm 24 of the caster 10 and the surface 104 by the brake pad 102 is what is desired and attained.

This eliminates the possibility of movement occurring intermediate the wheels 14-18 and the surface 104, a problem with prior types of caster brakes which can cause unwanted movement of the object being supported by the caster 10. It does not matter if the wheels 14-18 move or not, the object is stable and the caster 10 is applying a braking force directly to the surface 104.

Depending on the intended application of the caster 10, the amount of compression of the pad 102, the material chosen for the pad 102, and the stroke of the brake lever 110 (i.e., the downward and upward range of extension of the brake pad 102) are varied as desired. These and other factors are all design-specific variables. Accordingly, the brake assembly 100 is locked and engaged with the surface 104. It is latched in the second position and cannot be dislodged or released without further action, as described hereinafter.

It is also readily apparent to the user whether or not the brake assembly 100 is engaged. If the brake lever 110 is raised (i.e., if it is close to the flange plate 26), the brake is in the first position and no braking force is applied. If the brake lever 110 is displaced away from the flange plate 26, it is in the second position and maximum braking force is applied. A second stop pin 128 prevents over rotation of the brake pad support member 112.

The spring 116 is maximally compressed in the second position. This allows a constant force to be applied to the brake pad 102. The spring 116 also compensates for irregularities in the surface 104 and also for wear of the brake pad 102 over time.

FIG. 3d shows the brake assembly 100 being released from the second latched position. As shown, it is ready to automatically retract, under force supplied by the return spring 106, back into the first position.

To release the brake assembly 100, the brake release lever 120 is urged downward. As the brake release lever 120 is urged downward, the end rod 126 rotates. As the end rod 126 rotates, a bottom portion thereof contacts and bears against a brake release pin 130 that is attached to the brake lever 110.

As additional force is applied to the brake release lever 120 in a downward direction, the end rod 126 continues to bear against the brake release pin an amount sufficient to urge the opposite end 122b of the shaft 122 away from the pivot arm 24 until the opposite end 122b clears the latch plate 118, as shown in FIG. 3d.

The brake lever 110 is now free to return to the first position. Normally, the user allows the brake lever 110 to return quickly with a snap. An audible snap is heard on engagement and also on release. The spring 116 also supplies a force that, on release, helps urge the brake lever 110 to return to the first position.

If for some reason (i.e., an especially sensitive load being supported) and the user preferred, he or she could also gently allow the brake lever 110 to return to the first position rather than releasing all contact and allowing return spring 106 to urge it back abruptly.

Referring back to FIG. 4 momentarily, a roller sleeve 131 is disposed over the shaft 122 and is free to rotate about the shaft. The roller sleeve 131 is in contact with the latch plate 118 and because it rotates, it allows for easier and smoother operation.

Several important advantages are provided by the brake assembly 100. First, the location of brake is always the same when viewed from above. This allows the user to quickly access and apply the brake whereas with prior art caster brakes that are disposed on the wheels, their position varies and accordingly, they can not be quickly accessed as the wheels wobble or change directions.

Second, the brake can be applied safely and easily even while in transit. With prior art caster brakes, there is danger that the user can actually place his foot under the wheels where it can be run over or severely pinched. While not generally preferred, in an emergency or in anticipation of a needed stop, the brake assembly 100 can be quickly, safely, and predictably applied while in motion.

Third, the brake assembly 100 has two positions. The first position is no brake force whatsoever is applied. The second position is full, normal brake force is applied. The brake is either set (applied) or it is not. This produces predictable results. Prior caster brakes produce uncertain variable results where the braking force can vary widely. Worse yet, this variance can occur without any tactile or visual feedback occurring.

Prior caster brakes also are not securely latched and therefore are prone to sudden unpredictable release with possible damage to the object or even impact to people and other objects occurring.

Fourth, the report (noise) that occurs on setting (when the latch bar 122 snaps into place) and release provides a clear indication of the braking status to the user. When the brake is set, the user feels this engagement, typically through his shoe and into his foot. It is similarly felt on release. Either position can be verified visually as well, thereby providing confirmation of position via three senses, hearing, feeling, and sight.

While various features of the illustrated brake are important with respect to the preferred articulated caster 10, the principles of the present invention are equally applicable to alternatively configured brake assemblies including those described in additional embodiments hereinafter. Moreover, the illustrated brake assemblies may be used with alternative casters, carriages, or other load-supporting devices without departing from the principles of the present invention.

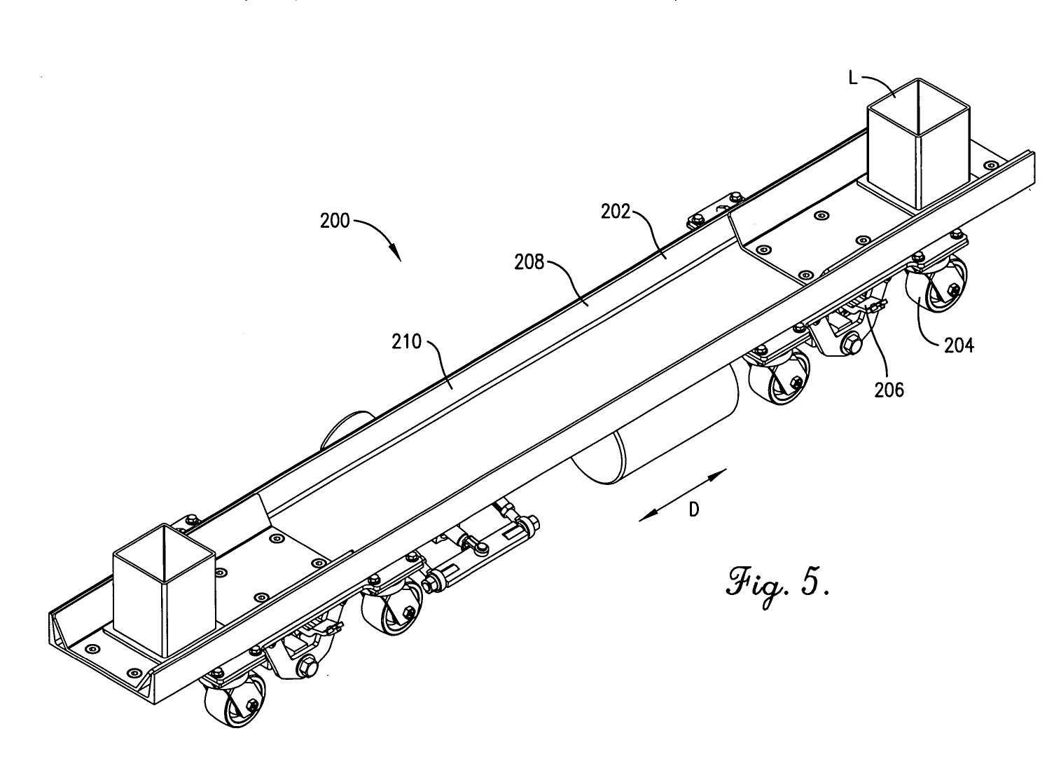

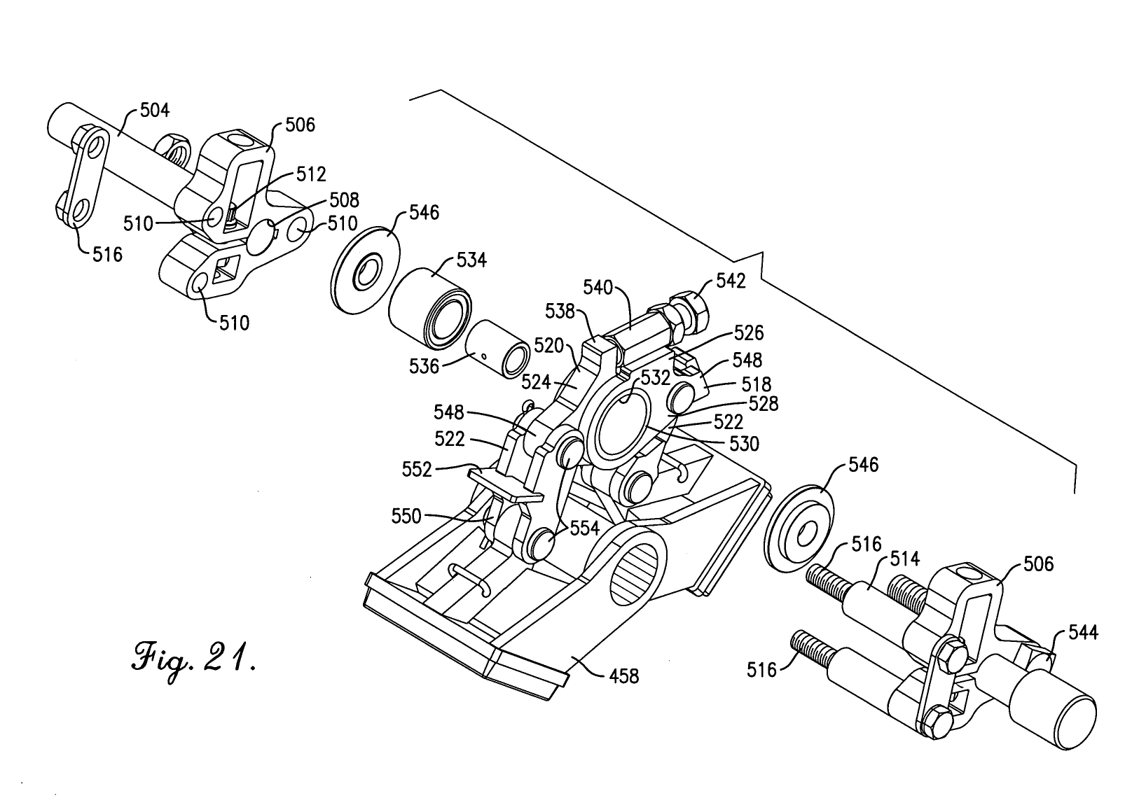

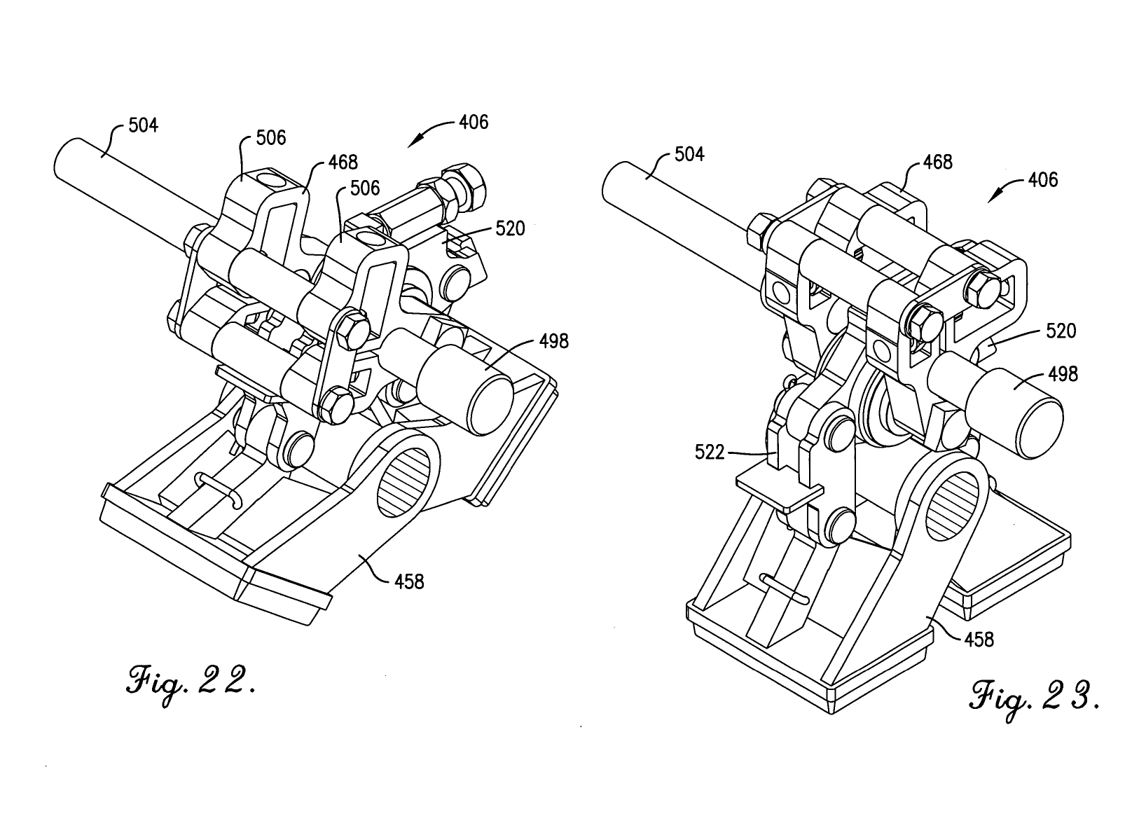

Turning to FIGS. 5-29, two alternative embodiments of the present invention are depicted. For the sake of brevity, the remaining description will focus primarily on the differences of these alternative embodiments from the preferred embodiment.

Initially turning to FIGS. 5-16, a carriage 200 is constructed in accordance with a second embodiment of the present invention. Again, the carriage 200 provides a stable platform for supporting relatively large loads with small caster wheels on an irregular surface. The carriage 200 broadly includes a frame 202, casters 204, and a brake assembly 206.

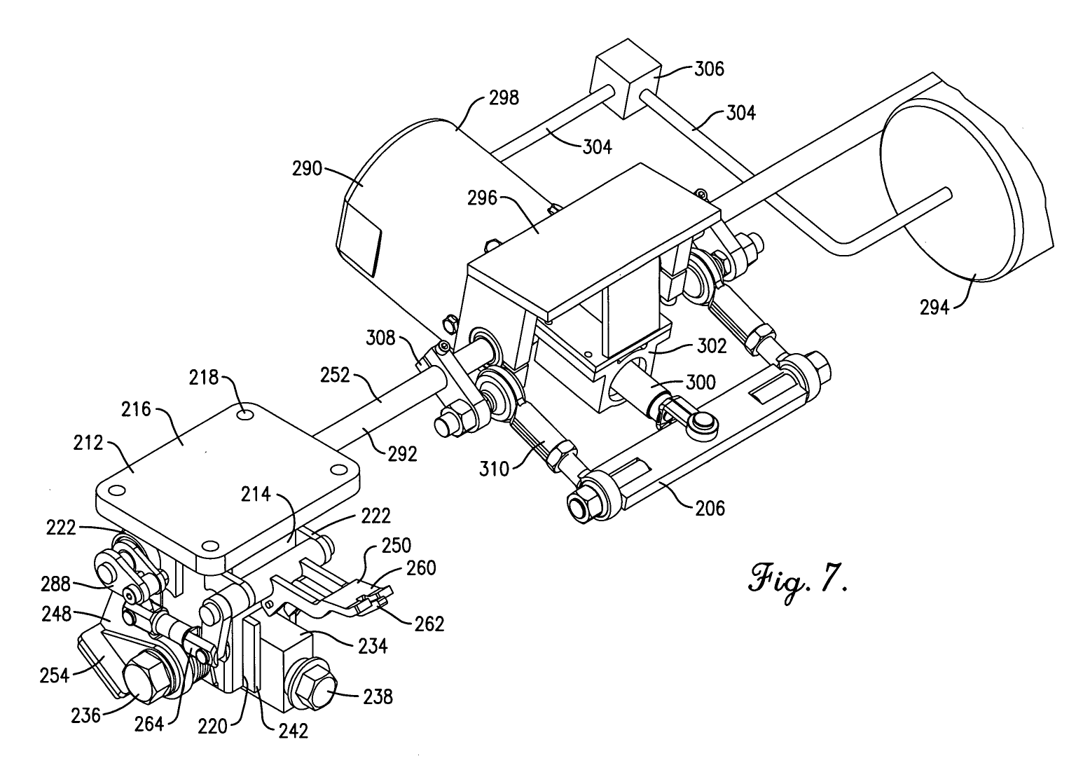

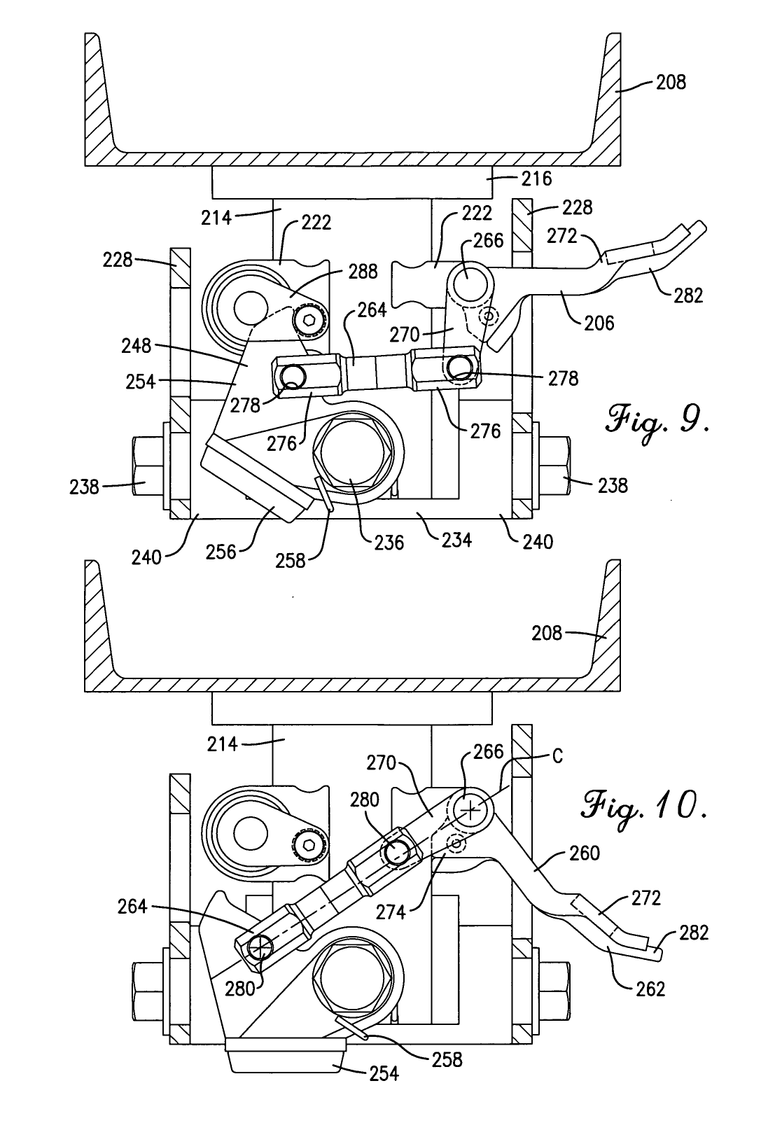

Referring to FIGS. 5-10, the frame 202 includes an articulated load-supporting section 208 including a substantially horizontal channel 210 and uprights 212. The uprights 212 (see FIG. 7) each include a post 214 and a flange 216 fixed to the post 214. The flange 216 includes holes 218 through which fasteners (not shown) extend for attaching the upright 212 to the channel 210. The post 214 includes a transverse slot 220 and a longitudinal bore (not shown). The uprights 212 further include brackets 222 (see FIG. 9) for attaching the brake assembly 206 to the section 208 as will be discussed. The principles of the present invention are equally applicable to a section 208 having an alternative shape or structure. As suggested above, the section 208 could include a chassis, cart, trailer, hand truck, or other mobile load-supporting structure.

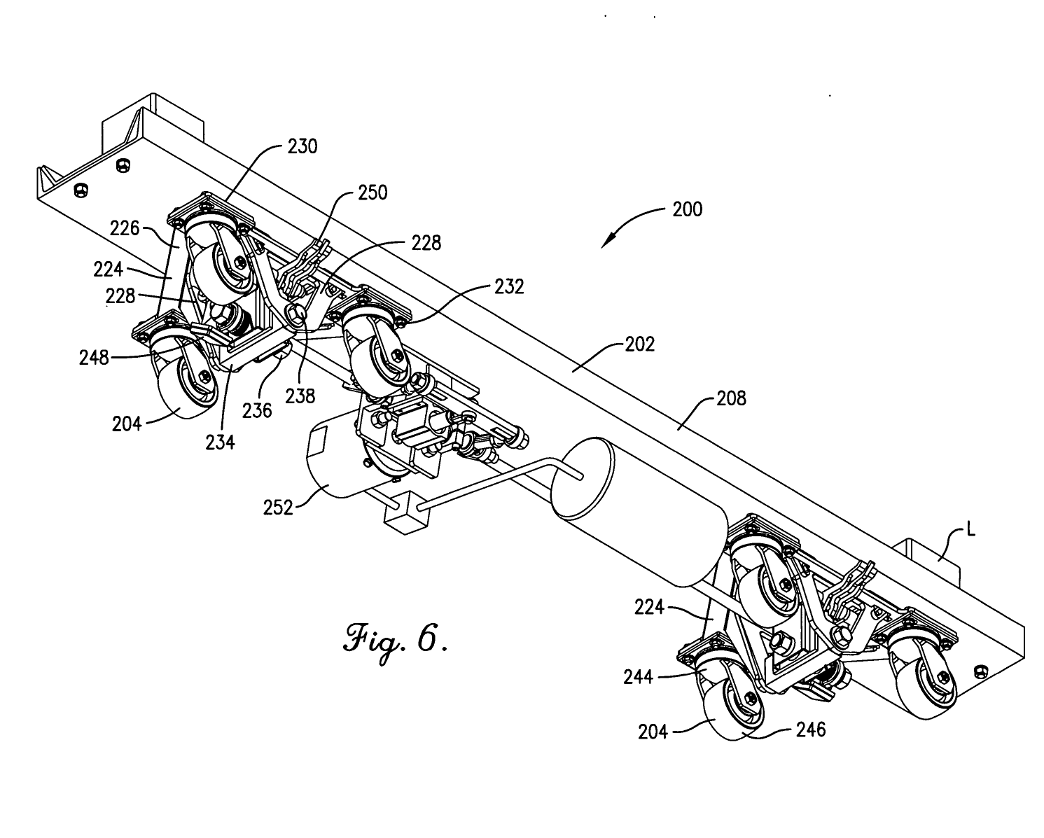

The assembled section 208 is relatively rigid and is thereby suitable for supporting a load L. The illustrated load L includes tubular legs welded to a flange that is positioned on the channel 210 (see FIGS. 5 and 6). However, the load L could be fastened, secured, or otherwise supported by the carriage 200 in a variety of configurations consistent with the principles of the present invention.

Turning to FIG. 6, the frame 202 further includes articulated base sections 224 that each interconnect three of the casters 204 in a triangular orientation. The base sections 224 are substantially unitary and rigid and each include a substantially flat caster attachment portion 226 and upright bracket portions 228 extending downwardly from the attachment portion 226. The bracket portions 228 have bores (not shown) that are aligned for purposes that will be discussed. The caster attachment portion 226 includes spaced apart flanges 230 with holes for receiving fasteners 232 that attach the casters 204 as will also be discussed. Additional details of another similarly constructed and preferred base section are disclosed in co-pending application for U.S. patent Ser. No. 10/886,369, filed Jul. 6, 2004, entitled ARTICULATED CASTER, which is hereby incorporated by reference herein.

Turning to FIGS. 6, 7 and 9, the frame 202 further includes an articulating block 234 with fasteners 236,238 for assembling the sections 208,224. The illustrated block 234 is a solid form and is elongated with ends 240 spaced apart so that the block 234 closely fits between the bracket portions 228. The block 234 further includes threaded bores (not shown) that extend from each end 240 and through-hole (not shown) that is perpendicular to the threaded bores and extends through the middle of the block 234. While the illustrated block 234 is solid and substantially shaped as a cuboid, the principles of the present invention are applicable to a block having alternative shapes and voids. For example, the block 234 may be formed in the shape of a hollow rectangular box.

Turning to FIGS. 6 and 9, the block 234 is arranged with each end 240 adjacent to one of the bracket portions 228. The threaded bores of the block 234 are aligned with the bores in the bracket portions 228. The bolt fasteners 238, which include a washer and a bushing that is received within the bracket portion 228, are threaded therein to secure the block 234 within the base section 224 and permit relative pivotal movement therebetween about an axis of the fasteners 238. The load-supporting section 208 is attached to the block 234 by arranging it in the transverse slot 220 and between a pair of spacers 242 (see FIG. 7). Also, the fastener 236 is extended through the longitudinal bore of the post 214 and the through-hole in the block 234. Thus, the load-supporting section 208 is pivotal relative to the block 234 about an axis of the fastener 236. Furthermore, the sections 208,224 are joined with the block 234 in a pin-and-block universal joint assembly so that the base section 224 is pivotal relative to the load-supporting section 208 with the axes being aligned longitudinally and transversely relative to the channel 210. However, the principles of the present invention are equally applicable to assembling the sections 208,224 with other types of universal joints or pivotal joints (e.g., a ball-and-socket joint). Additional details of the preferred universal joint assembly are disclosed in the incorporated 369 Application.

Turning to FIG. 6, the casters 204 include a pivotal body 244 with a flange portion and a pivotal portion that pivots relative to the flange portion about an upright axis. The casters 204 also include a caster wheel 246 that is rotatably mounted within the pivotal body 244. The caster wheel 246 is preferably made of nylon, but could also be made of other materials such as steel or rubber. The term caster, as used herein, is defined to be a rotatable wheel that is pivotally coupled to a structure, preferably about an upright axis.

As mentioned, the casters 204 are attached to the base sections 224 with fasteners 232 that extend through the flange portion and through holes in the base section 224. With respect to each of the base sections 224, three of the casters 204 are preferably spaced apart in a triangular arrangement with substantially equal spacing therebetween. The illustrated base section 224 and its respective casters 204 form a preferred caster assembly that is stable and can support itself independently of other supporting structure. For each base section 224, two of the casters 204 are longitudinally spaced fore-and-aft and aligned transversely. A third caster 204 is transversely spaced from the two casters 204 and longitudinally spaced between the two casters 204. The third caster 204 allows the caster assembly to support itself independently of other supporting structure. The caster assembly has a preferred direction of travel D so that the casters 204 travel sequentially over a particular location (see FIG. 5). While the preferred caster assembly has three casters 204 as discussed above, the principles of the present invention are applicable to a caster assembly with alternative types of wheels, alternative numbers of casters 204, or an alternative arrangement of the casters 204 relative to the base section 224.

In the usual manner, the casters 204 provide the base section 224 with pivotal rolling motion. In addition, each caster assembly is pivotal about the fasteners 236,238 and relative to the load-supporting section 208 to provide a “walking-beam” suspension. The walking-beam suspension permits all of the casters 204 attached to the base section 224 to remain in contact with the surface as the caster assembly travels over an obstacle or a generally uneven surface. The illustrated walking-beam also enhances load-sharing between the sections 224 and the individual casters 204.

Turning again to FIG. 5, the individual caster assemblies are arranged so that the preferred direction of travel D for each is aligned along the longitudinal direction of the channel 210. Thus, the preferred direction of travel for the illustrated carriage 200 is along the longitudinal direction of the channel 210. In traveling along the longitudinal direction, the casters 204 pass sequentially over a given location. This enhances the ability of the carriage 200 to negotiate obstacles without inadvertently becoming stuck. In addition, longitudinal travel over transverse obstacles is enabled by the transverse pivotal axis of the universal joint which permits pivotal movement. Thus, the illustrated carriage 200 provides an articulated caster arrangement. Additional preferred details concerning the illustrated arrangement of casters within the carriage as well as other preferred caster arrangements are disclosed in the incorporated application Ser. No. 10/886,369.

Turning to FIGS. 6-15, the preferred carriage 200 includes the shiftable brake assembly 206. The preferred brake assembly 206 includes a manual actuator 250, and a pneumatically-controlled actuator 252 attached to the load-supporting section 208 (see FIG. 7). As shown in FIGS. 7 and 9, the brake assembly 206 includes a brake arm 254 including a wear pad 256 and a torsion spring 258. The wear pad 256 preferably includes a soft, elastomeric material that deforms under stress. The wear pad is preferably adhered to the brake arm 254, but could also be fastened to the brake arm 254 by methods known to those of ordinary skill in the art.

The brake arm 254 is rotatably mounted on a sleeve (not shown) that projects from and is fixed to the post 214, with the longitudinal fastener 236 extending through the sleeve. The brake arm 254 is thereby pivotal between engagement and disengagement positions with a surface. However, the principles of the present invention are equally applicable to a brake with a ground engaging structure that has an alternative shifting motion. For example, an alternative brake may include a brake arm that translates into and out of a surface engaging position consistent with the principles of the present invention. The torsion spring 258 is mounted on the longitudinal fastener 236 between the brake arm 254 and the post 214. The spring 258 engages the brake arm 254 and post 214 to bias the brake arm 254 away from a braking or engaged position (abutting the surface as in FIG. 10) toward a released or disengaged position (see FIG. 9) where the brake arm 254 is spaced to its farthest extent from the surface. When in the braking position, the wear pad 256 is compressible in response to pressure applied to the brake arm 254.

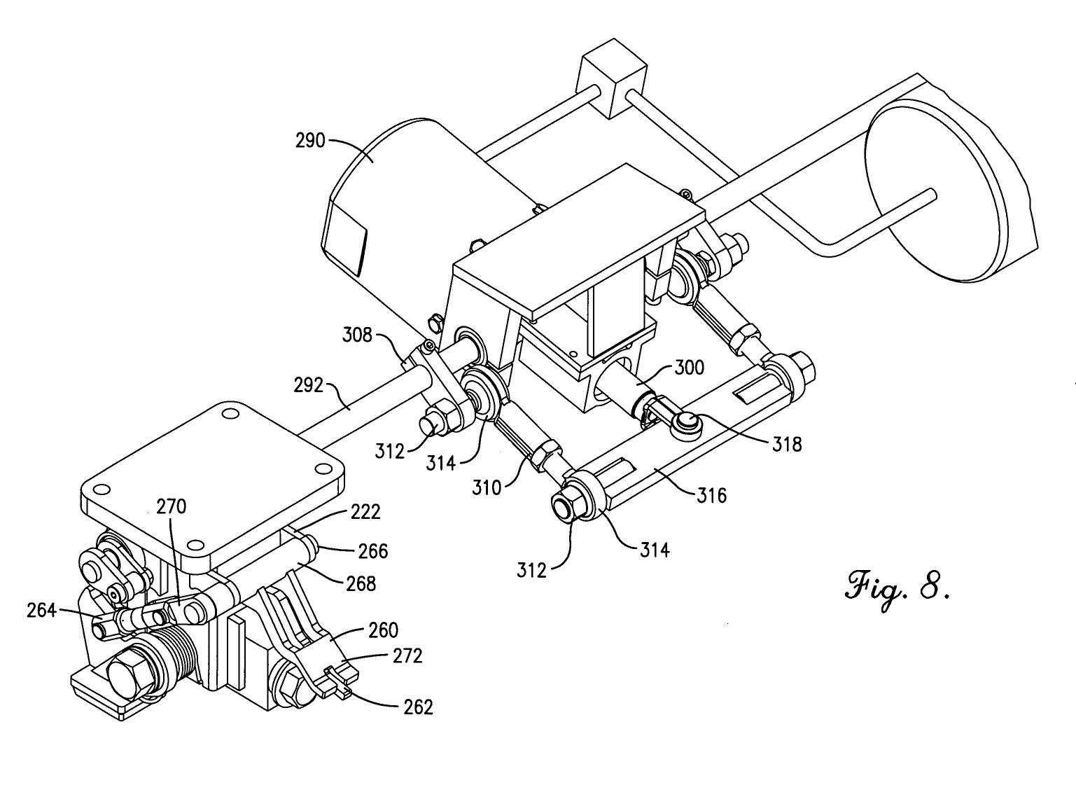

Turning to FIGS. 7-14, the manual actuator 250 provides a control mechanism for shifting the brake assembly 206 between the engaged and disengaged positions. The manual actuator 250 preferably includes a brake control lever 260, a brake release lever 262, and a link 264. The brake control lever 260 includes a pin 266 mounted to the brackets 222 and a sleeve 268 mounted on the pin 266 (see FIG. 8). The brake control lever 260 also includes an arm 270 fixed to an end of the pin 266 and a pedal 272 fixed to the sleeve 268. The pedal 272 includes a stop 274 (see FIG. 10). The brake control lever 260 rotates about an axis of the pin 266 between the engaged and disengaged positions (see FIGS. 9 and 10).

Turning to FIGS. 9 and 10, the link 264 includes slotted yoke ends 276 with through-holes 278 that are interconnected by a threaded rod (not shown) that permits the ends 276 to be adjustably spaced relative to each other. The slotted ends 276 receive the arm 270 and brake arm 254 so that the link 264 is pivotal relative to the arm 270 and brake arm 254. Pins 280 extend through the holes 278 and respectively through holes in the arm 270 and brake arm 254 to provide pivotal movement. Thus, the brake arm 254, link 264, and arm 270 are pinned together and form a four-bar linkage.

As shown in FIGS. 9 and 10, the rotational position of the brake control lever 260 determines where the brake arm 254 will be located between the braking and released positions. In the released position, the brake arm 254 and pedal 272 are shifted into an uppermost position (see FIG. 9). In the braking position, the pedal 272 is shifted downwardly until the stop 274 abuts against the post 214 (see FIG. 10). Between the positions, the brake arm 254 has a maximum displacement position (not shown) where the brake arm 254 is extended to a lower-most depth relative to the frame 202. In this position, the ends 276 are aligned with the pin 266 (see FIGS. 9 and 10) so that the brake arm 254 is rotated to its farthest counterclockwise position. Moreover, this position is defined by the axes of pins 280 and 266 being substantially collinear, with this line being indicated by phantom line C. The maximum displacement position is variable by adjusting the length of the link 264. The force applied by the floor surface to the brake arm 254 applies a compressive force to the link 264 and arm 270. Thus, the link 264 and arm 270 are encouraged to pivot away from the maximum displacement position to either of the engaged or disengaged positions. This results in the maximum displacement position being an inherently unstable position when force is applied to the link 264 and arm 270.

As the brake assembly 206 moves from the disengaged position to the engaged position, the brake arm 254 initially shifts in a generally downward direction from the released position to engage the surface in the maximum displacement position. Then, the brake arm 254 continues from the maximum displacement position to the braking position by shifting in a generally upward direction. The over-center condition of the brake assembly 206 is highly beneficial in retaining the brake arm 254 in the braking position. Specifically, the compressive force generated by engagement with the surface urges the brake arm 254 upwardly, which causes the brake arm 254 to be further retained in the braking position 254. The spring 258 further urges the brake arm 254 in the upward direction. It is particularly noteworthy that this upward direction is opposite to the direction (i.e., downwardly past the maximum displacement position) that the brake arm 258 must move to disengage the brake. The only way to disengage the brake requires the linkage to be purposefully passed back over center, causing the brake arm 254 to move past the maximum displacement position. This, of course, increases the compressive force experienced by the arm 254, which is naturally prevented unless the linkage is forced over center.

Again, as the brake assembly 206 disengages, the brake arm 254 initially shifts in a generally downward direction from the braking position to the maximum displacement position. The brake arm 254 then shifts in a generally upward direction from the maximum displacement position to the released position.

Turning to FIG. 11, the brake release lever 262 includes a pedal 282, a pin 284, and a stop 286. The lever 262 is rotatably mounted to the brake control lever 260 by extending the pin 284 through both pedals 272,282. The lever 262 further includes a torsion spring (not shown) that biases the pedal 282 into an upper-most engagement position with the pedal 272 (see FIGS. 9 and 10). The lever 262 cooperates with the brake control lever 260 to disengage the brake arm 254. As shown particularly in FIG. 11, the depressed lever 262 causes the brake control lever 260 to be rotated counterclockwise until the arm 270 is shifted past the maximum displacement position C. From this point, force applied to the brake arm 254 by the torsion spring 258 will shift the manual actuator 250 back to the disengaged position.

As the brake arm 254 engages the surface, the wear pad 256 contacts the surface, preferably so that pressure is distributed across the entire wear pad 256. When a sufficient pressure is applied, the wear pad 256 deforms so that its thickness becomes smaller. The elastomeric nature of the preferred wear pad 256 permits this deformation and causes the wear pad 256 to act like a spring. This also permits the wear pad 256 to better grip the surface through the combination of deformation and frictional engagement.

Turning again to FIGS. 6-15, the pneumatically-controlled actuator 252 also provides a mechanism for actuating the pivotal brake assembly 206 between the engaged and disengaged positions. In the illustrated embodiment, the actuator 252 is redundant to the manual actuator 250 in that it independently controls shifting of the brake arm 254 into the engagement position. However, the principles of the present invention are equally applicable where the carriage 200 includes only one of the actuators 250,252. It is also entirely within the ambit of the present invention to utilize other types of actuators (e.g., manually controlled actuators, electric actuators, etc.).

Referring to FIG. 7, the actuator 252 broadly includes brake control levers 288, a spring brake 290, a shaft 292 interconnecting the spring brake 290 and levers 288, and a pressure vessel 294. The shaft 292 is rotatably mounted within the bracket 222 on the post 214 and to a mounting bracket 296. The levers 288 are mounted on respective ends of the shaft 292 and engage the brake arm 254 as will be discussed further below. The shaft 292 is rotated by the spring brake 290. In the usual manner, the spring brake 290 includes a cylinder housing 298 and a cylinder rod 300 that translates into and out of the cylinder housing 298. The spring brake 290 is supported by the mounting bracket 296 and a linear bearing 302. A preferred spring brake is the MAXIBRAKE HR-Series Spring Brake, manufactured by Haldex Brake Products Corporation, 10707 N.W. Airworld Drive, Kansas City, Mo. 64153-1215. While the preferred actuator 252 uses a pneumatically-controlled spring brake 290, the principles of the present invention are equally applicable to other pneumatic actuators for engaging and disengaging the actuator, such as an air cylinder.

The pressure vessel 294 stores compressed air and fluidly communicates with the spring brake 290 through tubing 304 and valving 306 to provide a charge of compressed air. As previously noted, while the actuator 252 is preferably pneumatically-controlled, the principles of the present invention are also applicable to an actuator that uses hydraulic fluid. In that case, a similar spring brake or other actuating cylinder could be used and an accumulator could be used as the pressure vessel 294.

Turning to FIG. 8, the spring brake 290 is connected to the shaft 292 so that translational movement of the cylinder rod 300 is used to rotate the shaft 292. The pneumatic actuator 252 includes clamps 308 that are removably fixed to the shaft 292. The pneumatic actuator 252 also includes an adjustable link 310 that is pivotally attached to each clamp 308 by a fastener 312. The adjustable link 310 has ends 314 that each include a ball joint. Ends 314 of each link 310 are interconnected by bar 316. The bar 316 is connected to the cylinder rod 300 by a clevis and pin assembly 318.

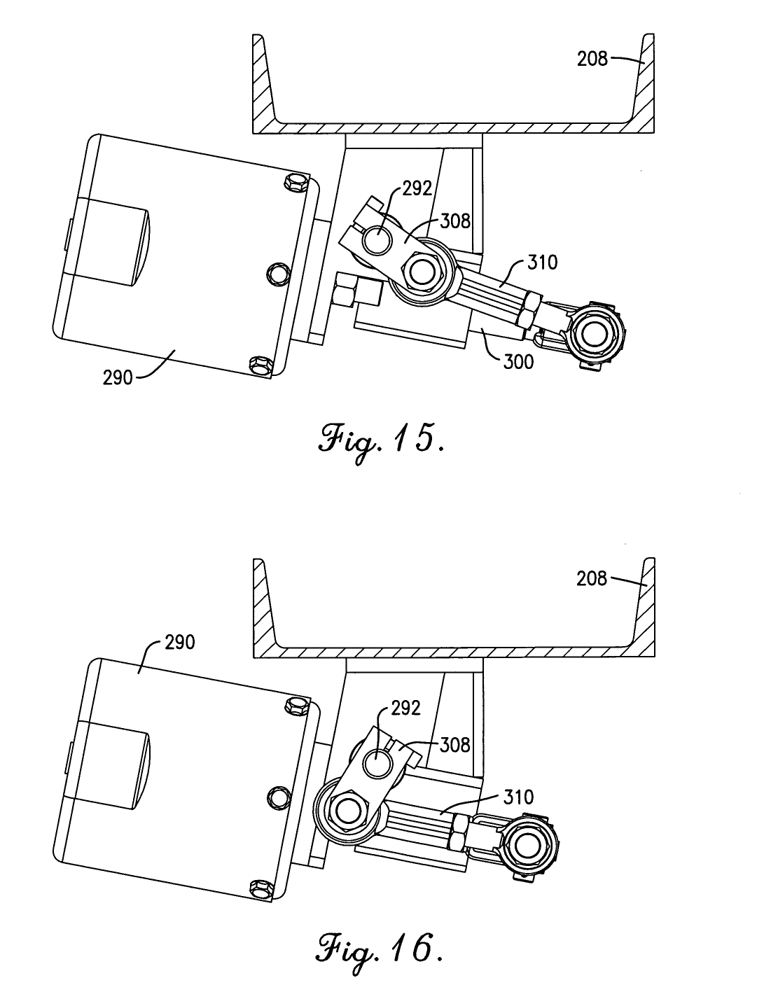

Referring to FIG. 7, the spring brake 290 and pressure vessel 294 are normally filled with pressurized gas so that the cylinder rod 300 is fully extended. The rod 300 drives the link 310 and clamps 308 to rotate the shaft 292 and lever 288 into the farthest counterclockwise position (see FIGS. 11 and 15). When the valving 306 is activated by a controller (not shown) the pressurized air within the spring brake 290 is evacuated and the cylinder rod 300 is forcefully and quickly retracted toward the cylinder housing 298. In this manner, the shaft 292 and lever 288 are forcefully driven to their farthest clockwise position (see FIGS. 12 and 16). The characteristics of the preferred spring brake 290 provide a substantially immediate engagement of the brake arm 254 that makes the pneumatic actuator 252 ideally suited for use as an emergency brake. In particular, the user may opt to use the emergency brake feature when the manual actuator 250 is not easily accessible. Moreover, the controller (not shown) may be variously configured to be operable at a distance from the carriage 200 for additional safety and convenience. For example, the valving 306 may be controlled by a safety switch that must be manually depressed to keep the brake disengaged.

The spring brake 290 is subsequently disengaged by activating the valving 306 so that the pressure vessel 294 refills the spring brake 290 and the cylinder rod 300 returns to its extended position. The preferred pressure vessel 294 is of sufficient volume so that the spring brake 290 may be refilled several times without refilling the vessel 294.

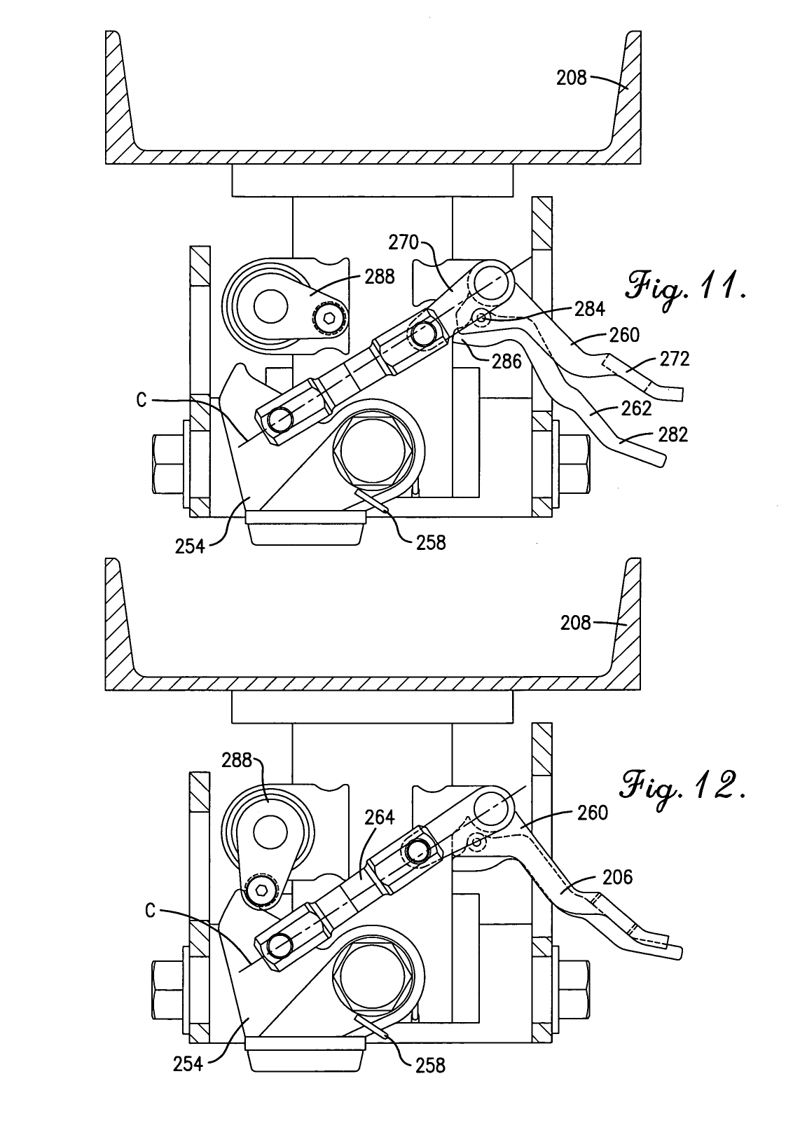

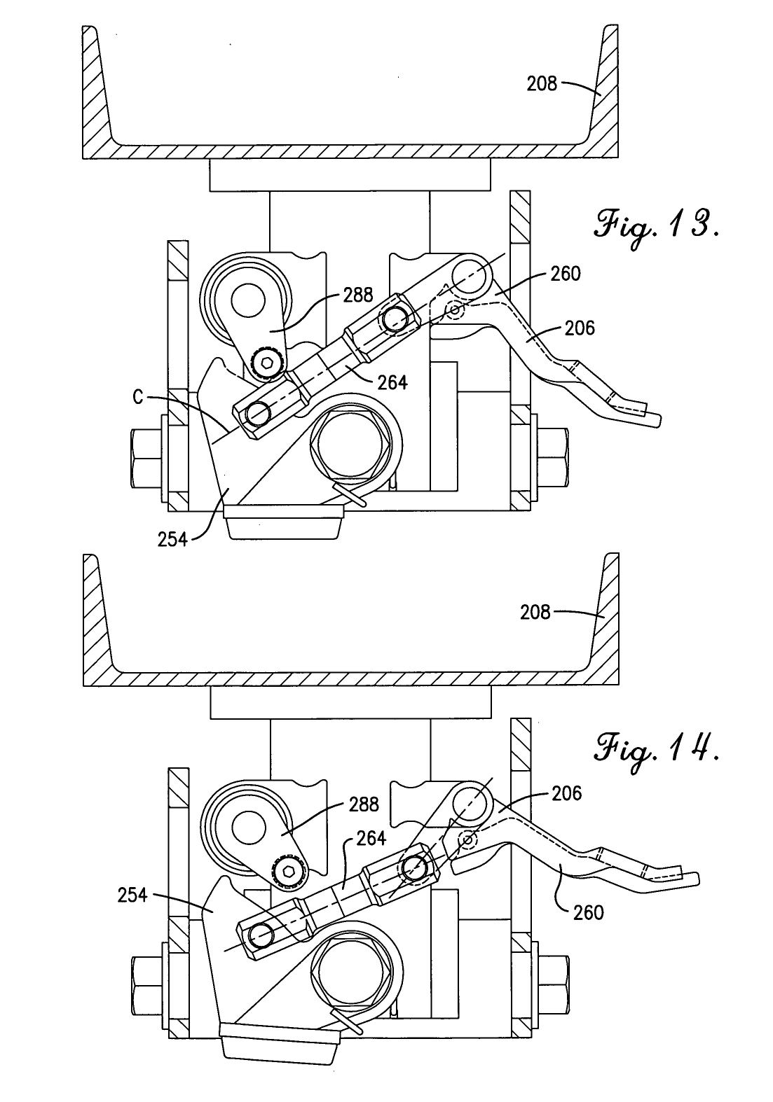

Turning back to FIG. 9, the brake control lever 288 is normally retracted so that the brake arm 254 may return to its released position where it abuts against the lever 288. The lever 288 engages by rotating clockwise until it moves the brake arm 254 into its engaged position (see FIG. 12). Normally, the link 264 is not shifted above the maximum displacement position C when the lever 288 engages the brake arm 254. Thus, the brake arm 254 is retracted by the torsion spring 258 when the lever 288 is returned counterclockwise. Where the link 264 is inadvertently shifted beyond the position C after the lever 288 engages (e.g., by depressing the pedal 272), the lever 288 can still disengage the brake assembly 206. As the lever 288 is driven by the actuator 252 to return the brake arm 254 to its released position, it contacts the link 264 (see FIG. 13) and forces it move past the maximum displacement position C (see FIG. 14) so that the brake arm 254 is free to return to the disengaged position.

The illustrated brake assembly 206 enables the carriage 200 to support various loads without physically interfering with the load. In particular, the brake assembly 206 is spaced entirely below the load-supporting surface of the frame 202. In this manner, the brake assembly 206 minimally impacts placement of the load on the carriage 200 and enables the carriage 200 to have a relatively low profile.

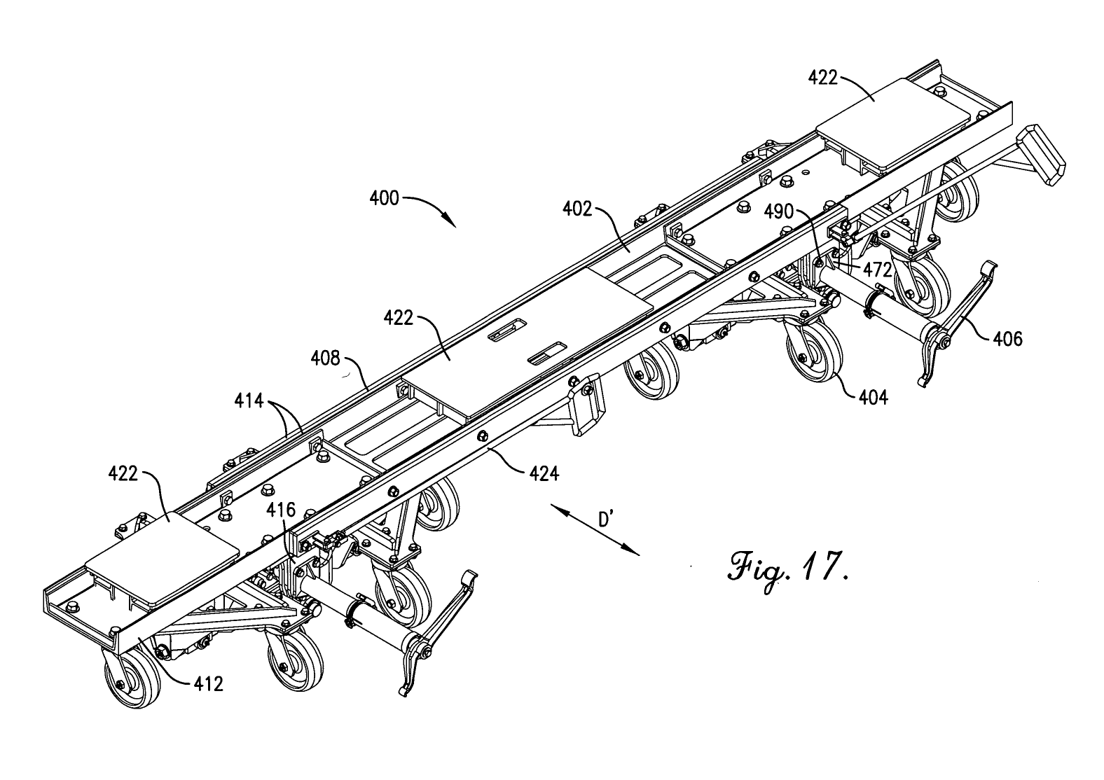

Turning to FIGS. 17-26, a third embodiment of the present invention is depicted. An alternative carriage 400 broadly includes an alternative frame 402, casters 404, and an alternative brake assembly 406.

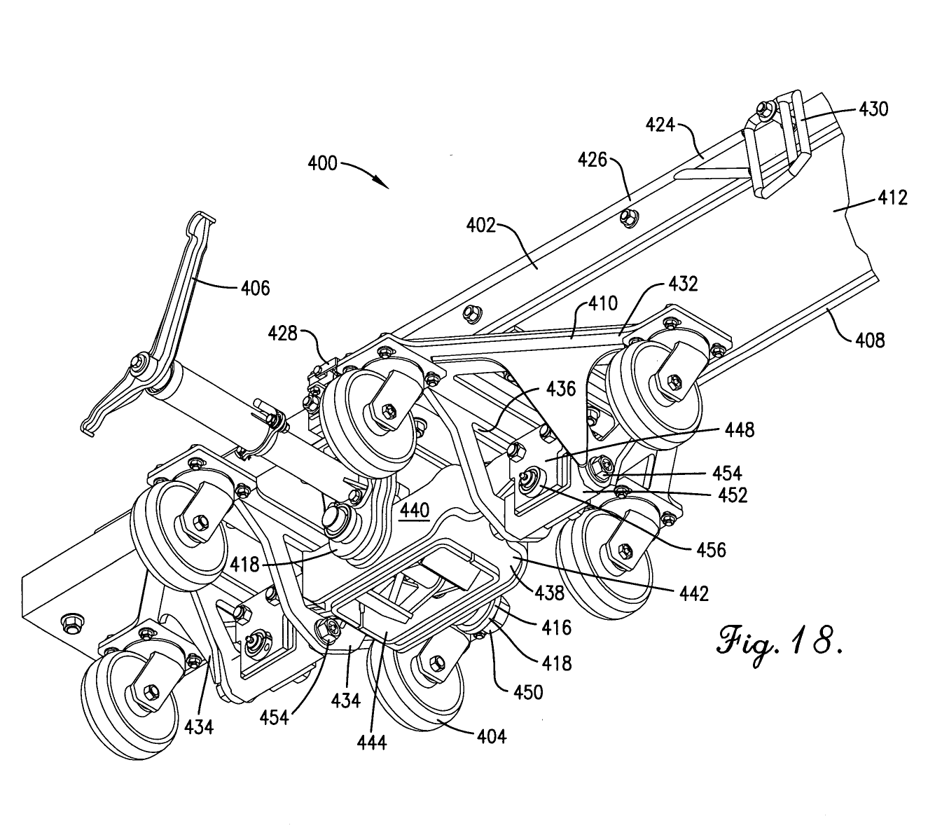

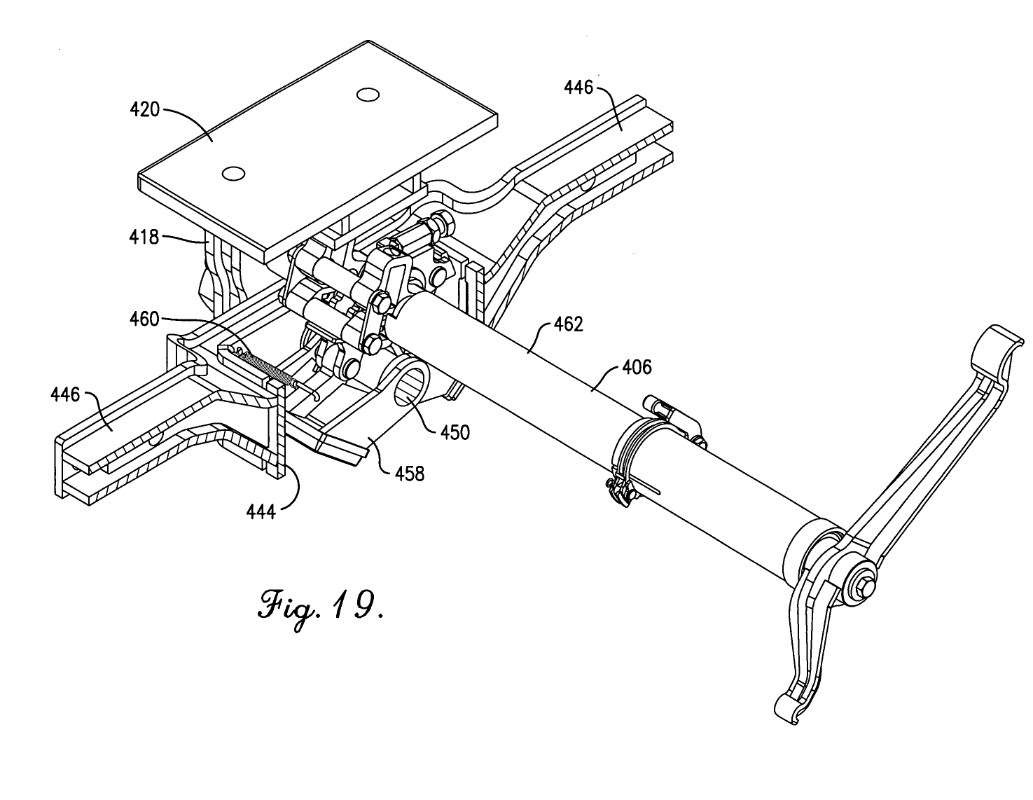

Referring to FIGS. 17 and 18, the frame 402 includes a load-supporting section 408 and pivotal sections 410 adjacent each end of the load-supporting section 408 and articulated relative to the load-supporting section 408. The load-supporting section 408 includes a channel 412 and stiffeners 414 bolted to the sides of the channel 412 to provide the frame 402 with additional strength. The channel 412 defines a longitudinal direction of the frame 402. The load-supporting section 408 further includes removable brackets 416 that are bolted to the channel 412. The brackets 416 include downwardly extending arms 418 fixed to a flange 420 (see FIG. 19). The load-supporting section 408 further includes removable load plates 422 that are received in the middle and along respective ends of the load-supporting section 408. The load-supporting section 408 further includes collapsible handles 424 bolted to the channel 412. The handles 424 include a rod 426 pivotally mounted on a joint 428 and a grip 430 on a distal end of the rod 426.

The pivotal sections 410 each include base sections that are similarly shaped and configured to base sections 224. The base sections are substantially unitary and rigid and each include a substantially flat caster attachment portion 432 and upright bracket portions 434 extending downwardly from the attachment portion 432. One of the bracket portions 434 has an opening 436, the purpose of which will be discussed shortly.

Referring to FIG. 18, the pivotal sections 410 also include an intermediate section 438 that pivotally interconnects base sections and load-supporting section 408. The intermediate section 438 comprises a beam 440 including a body 442 presenting an open cavity 444, opposite arms 446 (see FIG. 19), and end plates 448 fastened to the arms 446. The beam 440 extends horizontally and longitudinally, and is pivotally attached to the brackets 416 with a bolt 450 that extends through both bracket arms 418 and the beam 440. While the preferred intermediate section 438 extends along the longitudinal direction, the principles of the present invention are also applicable where the intermediate section 438 extends transversely or at an angle between the longitudinal and transverse directions. Moreover, the intermediate section 438 could be alternatively shaped to include more than two arms 446, so that more than two base sections 410 can be attached thereto. While the illustrated intermediate section 438 is pivotal about a single transverse axis relative to the load-supporting section 408 (i.e., the axis of bolt 450), the principles of the present invention are also applicable where the intermediate section 438 is pivotal about more than one axis through the use of a universal joint, such as a ball-and-socket joint, or other similar joint.

While the illustrated pivotal sections 410 include the intermediate section 438 pivotally attached to the base sections, the principles of the present invention are also applicable to the pivotal sections 410 including only one or more base sections (as shown in the embodiment of FIGS. 5-16) or only the intermediate section 438 (with at least two wheels attached thereto).

The frame 402 further includes articulated blocks 452 that are pivotally attached to the bracket portions 434 with fastener 454. The articulated block 452 is also pivotally attached to the beam 440 by extending the respective arm 446 through the respective opening 436 of the base section 410. The arm 446 is pivotally connected to the block 452 by fasteners 456 that extend through end plates 448 and a respective block 452. As in the second embodiment, the base sections 410 are pivotal around the orthogonally related axes of the fasteners 454,456 and each provide a walking-beam suspension relative to the load-supporting section 408. Furthermore, the sections 408,410 are joined with the block 452 in a pin-and-block universal joint assembly so that the sections 410 are pivotal relative to the load-supporting section 408 with the axes being aligned longitudinally and transversely relative to the channel 412.

The base sections 410 are preferably arranged so that their preferred direction of travel D is transversely oriented (see FIG. 17). However, the principles of the present invention are equally applicable to the base sections 410 being oriented so that their preferred direction of travel D is longitudinal or at an angle between the longitudinal and transverse directions.

The casters 404 are fastened to the base sections 410 as discussed in the previous embodiments. As mentioned, each base section 410 and its respective casters 404 provide a pivotal caster assembly that operates like a walking-beam suspension relative to the rest of the frame 402. In addition, the illustrated intermediate section 438 operates like a walking-beam suspension by permitting independent vertical movement of the base sections 410. The frame 402 therefore provides a compound walking-beam assembly that is particularly useful for buffering the load-supporting section 408 from irregularities in the surface over which the carriage 400 travels. The compound walking-beam is especially suited for traveling over irregular surfaces while minimizing vertical displacement of the load-supporting section 408. Additional details of a similar preferred walking-beam suspension used in conjunction with a carriage are disclosed in the incorporated application Ser. No. 10/886,369.

Turning to FIGS. 18-25, the brake assembly 406 includes opposite pivotal brake arms 458 that are pivotally mounted on the bolt 450 and within the cavity 444 and define a brake arm pivot axis. The brake assembly also includes springs 460 that bias the brake arms 458 into an uppermost released (or disengaged) position (see FIGS. 18 and 19). As will be discussed, the brake arms 458 are simultaneously pivoted in opposite rotational directions to engage the brake assembly 406. While there are certain useful features associated with arranging the brake arms 458 oppositely from each other, the brake arms 458 could have an alternative orientation without departing from the scope of the present invention. Additionally, the brake arms 458 could be sequentially shifted into the braking position.

Turning to FIGS. 19 and 26-29, the brake assembly 406 further includes a brake control lever 462 attached to the bracket 416 which provides a manual actuator. The lever 462 includes a housing 464, a shaft 466, lever throw 468, and pedal 470. The housing 464 includes a flange 472 (see FIG. 17) with slotted holes (not shown), a telescopic tube 474 fixed to the flange 472, and a clamp 476. The telescopic tube 474 includes tubing sections 478,480, and bearings 482 that are secured within the tubing sections 478,480 by snap rings 484. The tubing section 478 includes a circumferential projection 486 at one end that extends only partly around the section's circumference. The tubing section 480 includes a slotted end 488 which receives the tubing section 478. The clamp 476 is releasably secured around the slotted end 488 to selectively secure the sections 478,480 relative to each other. The housing 464 is attached to the bracket 416 with fasteners 490 that extend through the slotted holes of the flange 472 and are threaded into the housing 464. The slotted holes permit the housing 464 to be adjustably positioned for purposes that will be discussed.

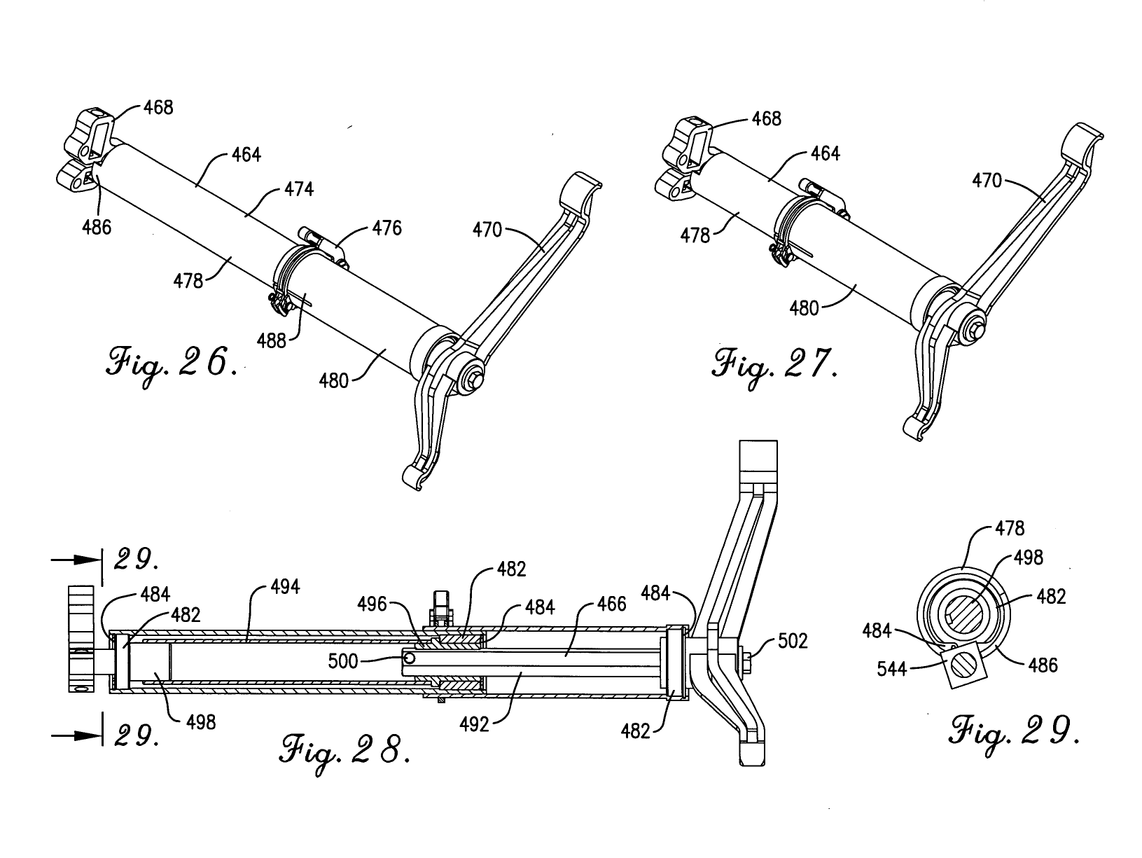

The shaft 466 is telescopic and includes hex rod 492, internal tube 494, bushing 496, and stub shaft 498. The hex rod 492 includes a transverse through-hole (not shown) adjacent to one end that receives a pin 500. The bushing 496 is received over the hex rod 492 and is slidable relative thereto with its travel being limited by the pin 500. The hex rod 492 is attached to the internal tube 494 by fixing the bushing 496 to the internal tube 494. Thus, the hex rod 492 is permitted to slide relative to the internal tube 494. The stub shaft 498 is fixed to the internal tube 494 at an end opposite from the bushing 496. The shaft 466 is received within the housing 464 and supported by bearings 482. The pedal 470 is attached to an end of the hex rod 492 with a bolt 502 and is operable to drive the hex rod 492, which in turn drives the bushing 496, internal tube 494, and stub shaft 498. Moreover, the lever 462 is operable to telescope in (see FIG. 27) and out (see FIG. 26) so that the pedal 470 may be selectively spaced from the bracket 416. The selective pedal spacing permits a user to shift the pedal out from the bracket 416 if the load carried by the frame 402 extends laterally to limit access to the pedal 470.

Referring to FIG. 21, the lever 462 further includes a flange (not shown) similar to flange 472, a bearing (not shown) similar to bearings 480, and a second stub shaft 504. The flange and bearing are attached to the opposite side of the bracket 416 from the flange 472 and support the stub shaft 504 therein.

The lever throw 468 includes two portions 506 each including a shaft bore 508, holes 510, and fasteners 512. The portions 506 are attached to each other with spacers 514 and fasteners 516 that extend through the holes 510 and spacers 514 to make the lever throw 468 substantially rigid and thereby operable to resist twisting or failure due to torque applied by the lever 462. The lever throw 468 is secured to the shaft 466 by attaching stub shaft 498 within the adjacent bore 508 and tightening the respective fastener 512. The lever throw 468 is also supported by securing stub shaft 504 within the opposite bore 508.

Referring to FIG. 21, the brake assembly 406 further includes a linkage 518, which is also part of the control mechanism, that interconnects the pivotal brake arms 458 and the brake control lever 462. The linkage 518 includes a pivotal rocker arm 520 and links 522. The rocker arm 520 includes inner and outer sections 524,526 that are pivotal relative to each other about a rocker arm axis. The outer section 526 includes a body 528, and a sleeve 530 that defines the rocker arm axis and around which the inner section 524 pivots. The sleeve 530 provides a bore 532 that receives a bearing 534 and an inner sleeve 536. The inner section 524 includes a stop 538. The outer section 526 includes a threaded sleeve 540 fixed to the body 528 for receiving a threaded fastener 542. The fastener 542 selectively engages the stop 538 so that the rocker arm sections 524,526 are adjustably spaced from each other.

The rocker arm 520 is pivotally secured to the lever throw 468 by attaching a square-headed bolt 544 through a pair of holes 510 in the lever throw 468 and through the bore of inner sleeve 536. In addition, washers 546 are spaced on opposite sides of the rocker arm 520, and between the rocker arm 520 and throw portions 506 to permit relative pivotal motion therebetween. The rocker arm 520 also presents pivotal ends 548.

The links 522 are rigid and each include a body 550 with holes on each end. A stop 552 is attached to one of the links 522. The links 522 are pivotally attached to a respective one of the pivotal ends 548 of the rocker arm 520 with pins 554. The links 522 are also pivotally attached to a respective one of the pivotal brake arms 458 with pins 554. In this manner, the rocker arm 520 interconnects the pivotal brake arms 458. Moreover, each of the sections 524,526 cooperate with a respective one of the links 522 and brake arms 458 to define a four-bar linkage. Thus, pivotal movement of the brake arm 458 causes the corresponding one of the sections 524,526 to pivot similarly. When the brake arms 458 are in the braking position, the force applied through the links 522 retains the rocker arm sections 524,526 in a rigid, abutting relationship. Furthermore, when the brake assembly 406 is engaged, pivotal movement of one brake arm 458 causes both sections 524,526 to pivot and, consequently, the other brake arm 458. This pivotal movement permits the brake arms 458 to adapt to an irregular or slanted surface by pivoting until both brake arms 458 contact the surface.

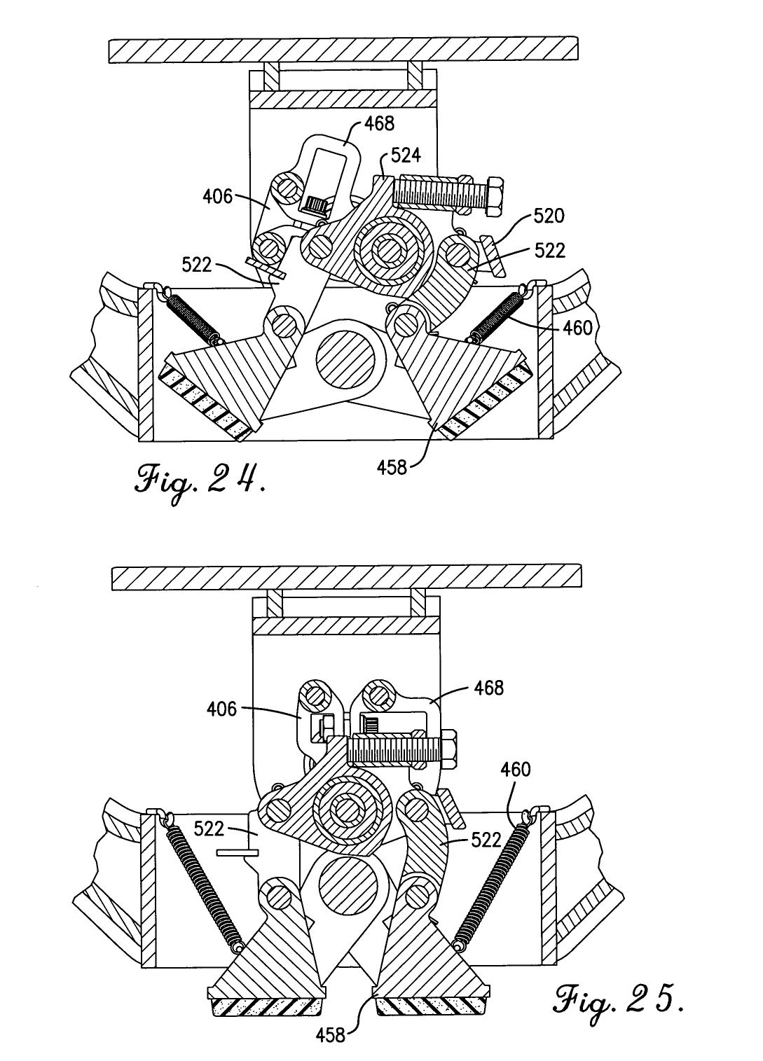

Referring to FIGS. 18, 19, 22, and 24, the brake assembly 406 is in the disengaged position when the lever 462 is rotated to its farthest counterclockwise position. In this position, the lever throw 468 is abutted against the stop 552 and the rocker arm 520 is shifted laterally away from the axis of bolt 450. Also, an additional stop is provided where the link 522 contacts a bottom surface of the rocker arm 524 (see FIG. 24). The brake arms 458 have a maximum displacement position where the rocker arm axis is collinear with the pivot axis of the shaft 466 and the axis of bolt 450.

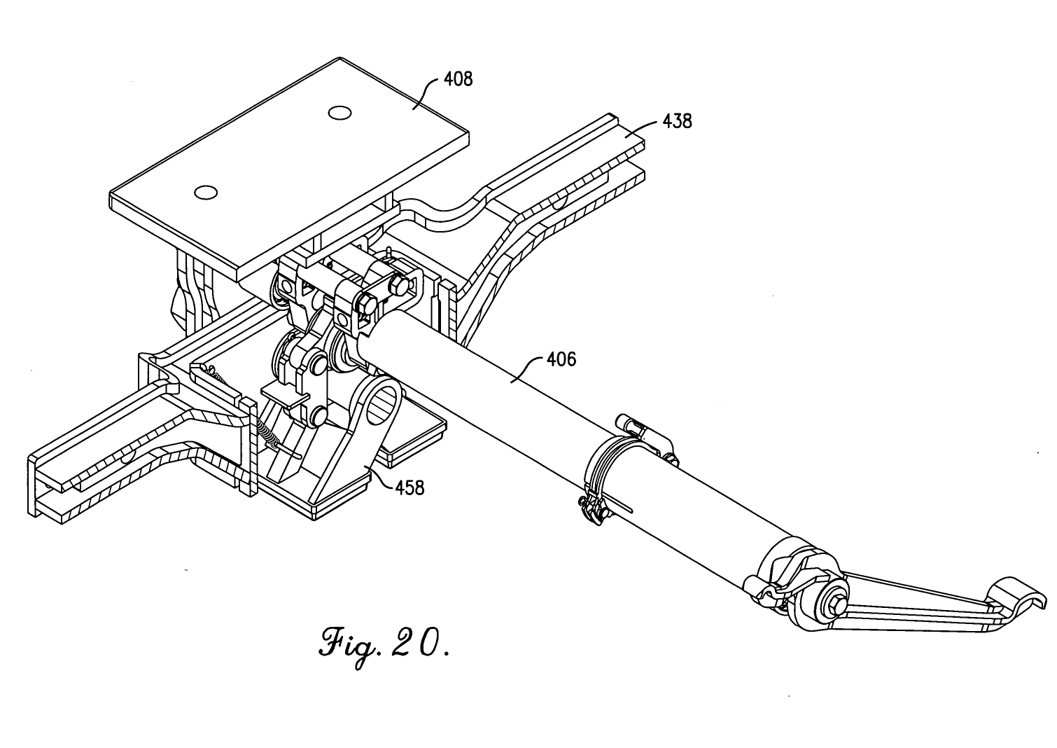

Referring to FIGS. 20, 23, and 25, the brake arms 458 are shifted beyond the maximum displacement position and into an over-center braking position by rotating the lever 462 to its farthest clockwise (or engagement) position. Thus, force applied to the brake arms 458 tends to retain the brake assembly 406 in this position. In the over-center position, the square-headed bolt 544 makes contact with the projection 486 on the telescopic tube 474 (see FIG. 29) so that the projection 486 serves as a stop to limit travel beyond the braking position.

The engaged (and over-center) position of the brake assembly 406 is adjustable. The slotted holes in the flange 472 allow the housing 464 to be rotated relative to the bracket 416. In this manner, the angular position of projection 486 can be adjusted to define the angle at which the bolt 544 contacts the projection 486. While the over-center feature of the brake assembly 406 is preferably enabled by the illustrated linkage 518, the principles of the present invention are equally applicable to other linkages or assemblies that provide an over-center mechanism for forcibly retaining the brake arms 458 in the braking position. For example, the brake assembly 206 provides another preferred over-center mechanism for forcibly retaining the brake assembly 206 in the engaged position. Moreover, other mechanisms including pivotal links or cams for providing a similar over-center feature are within the ambit of the present invention.

As the brake arms 458 engage the surface, the ends move downwardly and laterally toward each other. The brake arms 458 cooperate to apply downward pressure without introducing lateral movement into the carriage. This occurs because the opposing relationship of the brake arms 458 causes the brake arms 458 to counteract each other along the lateral direction. Moreover, because the preferred brake arms 458 include elastomeric wear pads, the wear pads deform and grip the surface due to the lateral sliding action as the brake arms 458 engage the surface. Thus, the brake arms 458 resist any lateral carriage movement during brake engagement.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A carriage for supporting a load above a surface, the carriage comprising:
a frame including a load-supporting section and a pivotal section,
said sections being pivotally coupled along a substantially horizontal axis;
a plurality of wheels including a pair of wheels attached to the pivotal section for supporting at least a portion of the load,
said pair of wheels being spaced oppositely from the axis so that the pivotal section operates as a walking beam; and
a brake shiftable into an engaged condition wherein the brake engages the surface for restricting carriage movement,
said brake being mounted to the frame and spaced between the pair of wheels so that the engaged brake at least partly supports the load.

2. The carriage as claimed in claim 1,
said plurality of wheels including a third wheel that is attached to the pivotal section so that the pivotal section is self-supporting.

3. The carriage as claimed in claim 2,
said wheels each being a caster.

4. The carriage as claimed in claim 1,
said brake being mounted to the load-supporting section.

5. The carriage as claimed in claim 4,
said pivotal section including an intermediate section,
said pivotal section including first and second base sections that are pivotally coupled to the intermediate section at spaced apart locations,
said intermediate section being pivotally coupled to the load-supporting section at a point between the locations so that the intermediate section operates as a walking beam.

6. The carriage as claimed in claim 5,
said base sections being pivotal along respective parallel lateral axes that are substantially orthogonal to the substantially horizontal axis,
said intermediate section being pivotal about the substantially horizontal axis.

7. The carriage as claimed in claim 1,
said frame sections being pivotally interconnected at a joint that provides relative movement about at least two substantially orthogonal pivot axes, one of which is the substantially horizontal axis,
said brake being mounted to the load-supporting frame section,
said brake being configured to engage the surface and thereby restrict carriage movement.

8. The carriage as claimed in claim 7,
said frame including an articulating block pivotally attached to the load-supporting section along a first one of the axes and pivotally attached to the pivotal section along a second one of the axes,
said brake including a brake arm that is mounted to the load-supporting section and is pivotal about the first axis.

9. The carriage as claimed in claim 1,
said brake being shiftable from the engaged condition to a disengaged condition wherein carriage movement is permitted,
said brake including a shiftable brake arm shifted into forcible engagement with the surface when the brake is positioned in the engaged condition,
said brake including a control mechanism for controlling shifting of the brake arm into and out of engagement with the surface,
said control mechanism and brake arm cooperating to forcibly retain the brake in the engaged condition.

10. The carriage as claimed in claim 9,
said brake arm shifting in opposite first and second directions relative to the load-supporting frame section,
said control mechanism causing the brake arm to shift between a braking position corresponding to the engaged condition of the brake, a release position corresponding to the disengaged condition of the brake, and an intermediate maximum displaced position,
said brake arm shifting in the first direction as the brake arm moves from the release position to the maximum displaced position and in the second direction as the brake arm moves from the maximum displaced position to the braking position.

11. The carriage as claimed in claim 10,
said first direction corresponding with movement of the brake arm into engagement with the surface.

12. The carriage as claimed in claim 10,
said control mechanism including a brake control lever that is pivotally attached to the load-supporting frame section about a lever pivot point,
said brake arm being pivotal about an arm pivot point,
said control mechanism including linkage operably coupled between the brake control lever and the brake arm and presenting at least one additional pivot point,
at least three of said pivot points being collinear when the brake arm is in the maximum displaced position,
said at least three of the pivot points forming an obtuse angle when the brake arm is out of the maximum displaced position.

13. The carriage as claimed in claim 12,
said linkage including a rigid link that is pivotally attached between the brake control lever and the brake arm to define first and second linkage pivot points,
said lever pivot point and said first and second linkage pivot points defining the at least three of said pivot points.

14. The carriage as claimed in claim 13,
said brake including a brake release lever shiftably attached to the brake control lever for pivoting the brake control lever in a release direction corresponding with movement of the brake arm out of the braking position in the first direction to at least the maximum displacement position.

15. The carriage as claimed in claim 13,
said link being adjustable in length to vary the maximum displacement position of the brake arm relative to the load-supporting frame section.

16. The carriage as claimed in claim 12,
said brake including a second shiftable brake arm similar in construction and function to the first-mentioned brake arm,
said lever being operably coupled via the linkage to both of the brake arms for simultaneously moving the brake arms between the respective positions thereof.

17. The carriage as claimed in claim 16,
said first directions of shifting for the brake arms being in opposition to one another, and said second directions of shifting for the brake arms being in opposition to one another, whereby movement of the carriage is restricted as the brake arms shift from the release position to the braking position.

18. The carriage as claimed in claim 16,
said linkage permitting the brake arms to cooperatively pivot relative to the load-supporting section while in the braking position, such that the arms are configured to engage an uneven portion of the surface.

19. The carriage as claimed in claim 18,
said linkage including a rocker arm lever and a pair of links, each being pivotally connected between the rocker arm lever and a corresponding one of the brake arms at respective linkage pivot points,
said brake lever being pivotally attached to the rocker arm lever at another linkage pivot point spaced between the pivot points joining the rocker arm lever and the links,
said rocker arm lever, links, and brake arms defining a four-bar linkage that provides the cooperative pivoting of the brake arms when in the braking position.

20. The carriage as claimed in claim 19,
said brake arms pivoting about a common arm pivot point,
said lever pivot point, the arm pivot point, and said another linkage pivot point defining the at least three of said pivot points.

21. The carriage as claimed in claim 1,
said brake including a shiftable brake arm shifted into a braking position when the brake is positioned in the engaged condition,
said brake including a brake control lever that is shifted into an engagement position when the brake arm is in the braking position,
said brake including a latch mechanism for releasably retaining the control lever in the engagement position.

22. The carriage as claimed in claim 1,
said brake including a manually operable brake control lever that is pivotally attached to the load-supporting frame section and is operable to shift the brake into and out of the engaged condition,
said brake control lever including a manually engageable surface against which a manual force is exerted to shift the lever,
said brake control lever including a pair of telescopically interfitted lever portions to permit adjustable lengthening of the brake control lever and thereby repositioning of the manually engageable surface,
said brake control lever further including a locking mechanism for selectively preventing relative telescopic shifting of the lever portions.

23. A carriage for supporting a load above a surface, the carriage comprising:
a frame configured to support the load;
a plurality of caster wheels pivotally attached to the frame for providing rolling movement over the surface; and
a brake operable to engage the surface in an engaged condition and thereby restrict movement of the carriage across the surface when in the engaged condition,
said brake including a shiftable brake arm shiftably attached to the frame for movement into and out of a braking position corresponding to the engaged condition of the brake,
said brake further including first and second brake control levers, each of which independently controls shifting of the brake arm into the braking position, wherein either control lever can be used to control engagement of the brake.

24. The carriage as claimed in claim 23; and
an on-board actuator for driving at least one of the control levers in a braking direction that corresponds with shifting of the brake arm to the braking position,
said on-board actuator being suitable for engaging the brake in emergency situations.

25. The carriage as claimed in claim 24,
said on-board actuator comprising a pressure-controlled actuator that serves to shift the at least one control lever in the braking direction depending upon pressure variation experienced thereby.

26. The carriage as claimed in claim 25,
said pressure-controlled actuator including a shaft fixed to the second lever and a spring operably coupled to the shaft,
said actuator further including a pneumatic pressure chamber operable to forcibly restrain the spring when the chamber is pressurized, with depressurization of the chamber permitting the spring to urge the second lever in the braking direction.

27. The carriage as claimed in claim 26,
said pressure-controlled actuator including a pressurized vessel for providing a charge of air to the pneumatic pressure chamber.

28. The carriage as claimed in claim 27,
said on-board actuator including a controlling valve assembly that controls pneumatic flow from the pressure chamber and pneumatic flow between the pressurized vessel and the pressure chamber.

29. The carriage as claimed in claim 24,
said on-board actuator being operable to drive only one of the control levers,
the other one of the control levers including a manually-engageable portion that is configured for manual actuation.

30. The carriage as claimed in claim 23,
said brake being shiftable from the engaged condition to a disengaged condition wherein carriage movement is permitted,
said brake arm being shifted into forcible engagement with the surface when in the braking position thereof,
said brake including a control mechanism for controlling shifting of the brake arm into and out of engagement with the surface,
said first and second brake control levers forming part of the control mechanism,
said control mechanism and brake arm cooperating to forcibly retain the brake in the engaged condition.

31. The carriage as claimed in claim 30,
said brake arm shifting in opposite first and second directions relative to the frame,
said control mechanism causing the brake arm to shift between the braking position, a release position corresponding to the disengaged condition of the brake, and an intermediate maximum displaced position,
said brake arm shifting in the first direction as the brake arm moves from the release position to the maximum displaced position and in the second direction as the brake arm moves from the maximum displaced position to the braking position.

32. The carriage as claimed in claim 31,
said first direction corresponding with movement of the brake arm into engagement with the surface.

33. The carriage as claimed in claim 31,
said first brake control lever being pivotally attached to the frame about a lever pivot point,
said brake arm being pivotal about an arm pivot point,
said control mechanism including linkage operably coupled between the first brake control lever and the brake arm and presenting at least one additional pivot point,
at least three of said pivot points being collinear when the brake arm is in the maximum displaced position,
said at least three of the pivot points forming an obtuse angle when the brake arm is out of the maximum displaced position.

34. The carriage as claimed in claim 33,
said linkage including a rigid link that is pivotally attached between the brake control lever and the brake arm to define first and second linkage pivot points,
said lever pivot point and said first and second linkage pivot points defining the at least three of said pivot points.

35. The carriage as claimed in claim 34,
said second control lever being shiftable into and out of an engagement position corresponding to the braking position of the brake arm,
said second control lever being configured to shift the brake arm from the braking position to at least the maximum displacement position as the second control lever shifts out of the engagement position.

36. The carriage as claimed in claim 35,
said second control lever contacting the link during shifting movement out of the engagement position to move the rigid link and thereby reposition the first and second linkage pivot points in collinear alignment with the lever pivot point.

37. The carriage as claimed in claim 35; and
an on-board actuator for driving the second control lever into and out of the engagement position.

38. The carriage as claimed in claim 37,
said brake including a brake release lever shiftably attached to the first control lever for pivoting the first control lever in a release direction corresponding with movement of the brake arm out of the braking position in the first direction to at least the maximum displacement position.

39. The carriage as claimed in claim 38,
said actuator preventing the brake release lever from shifting the first control lever in the release direction when the second control lever is in the engagement position.

40. The carriage as claimed in claim 23,
said frame including a load-supporting section and a base section,
said sections being pivotally coupled along a substantially horizontal axis;
said plurality of wheels including a pair of wheels attached to the base section for supporting at least a portion of the load,
said pair of wheels being spaced oppositely from the axis so that the base section operates as a walking beam,
said brake being mounted to the frame and spaced between the pair of wheels so that the engaged brake at least partly supports the load.

41. The carriage as claimed in claim 23,
said first brake control lever being pivotally attached to the frame and operable to shift the brake into and out of the engaged condition,
said first brake control lever including a manually engageable surface against which a manual force is exerted to shift the lever,
said first brake control lever including a pair of telescopically interfitted lever portions to permit adjustable lengthening of the brake control lever and thereby repositioning of the manually engageable surface,
said first brake control lever further including a locking mechanism for selectively preventing relative telescopic shifting of the lever portions.

42. A caster-supported carriage for supporting a load above a surface, the carriage comprising:
a load-supporting frame section;
a caster assembly including a base frame section and at least three spaced apart caster wheels that cooperatively support the base frame section so that the caster assembly is self-supporting,
said frame sections being pivotally interconnected at a joint that provides relative movement about at least two substantially orthogonal pivot axes; and
a brake mounted to the load-supporting frame section,
said brake being configured to engage the surface and thereby restrict carriage movement.

43. The carriage as claimed in claim 42,
said caster wheels being substantially equally spaced from each other.

44. The carriage as claimed in claim 42,
said casters defining a preferred longitudinal direction of travel for the caster assembly where the casters are sequentially longitudinally spaced.

45. The carriage as claimed in claim 44,
a first one of said pivotal axes of the joint being generally orthogonal to the longitudinal direction of travel.

46. The carriage as claimed in claim 45,
a second one of said pivotal axes of the joint being generally aligned with the longitudinal direction of travel.

47. The carriage as claimed in claim 42,
said brake being shiftable between an engaged condition wherein the brake restricts carriage movement and a disengaged condition wherein carriage movement is permitted,
said brake including a shiftable brake arm shifted into forcible engagement with the surface when the brake is positioned in the engaged condition,
said brake including a control mechanism for controlling shifting of the brake arm into and out of engagement with the surface,
said control mechanism and brake arm cooperating to forcibly retain the brake in the engaged condition.

48. The carriage as claimed in claim 47,
said brake arm shifting in opposite first and second directions relative to the load-supporting frame section,
said control mechanism causing the brake arm to shift between a braking position corresponding to the engaged condition of the brake, a release position corresponding to the disengaged condition of the brake, and an intermediate maximum displaced position,
said brake arm shifting in the first direction as the brake arm moves from the release position to the maximum displaced position and in the second direction as the brake arm moves from the maximum displaced position to the braking position.

49. The carriage as claimed in claim 48,
said first direction corresponding with movement of the brake arm into engagement with the surface.

50. The carriage as claimed in claim 48,
said control mechanism including a brake control lever that is pivotally attached to the load-supporting frame section about a lever pivot point,
said brake arm being pivotal about an arm pivot point,
said control mechanism including linkage operably coupled between the brake control lever and the brake arm and presenting at least one additional pivot point,
at least three of said pivot points being collinear when the brake arm is in the maximum displaced position,
said at least three of the pivot points forming an obtuse angle when the brake arm is out of the maximum displaced position.

51. The carriage as claimed in claim 50,
said linkage including a rigid link that is pivotally attached between the brake control lever and the brake arm to define first and second linkage pivot points,
said lever pivot point and said first and second linkage pivot points defining the at least three of said pivot points.

52. The carriage as claimed in claim 51,
said brake including a brake release lever shiftably attached to the brake control lever for pivoting the brake control lever in a release direction corresponding with movement of the brake arm out of the braking position in the first direction to at least the maximum displacement position.

53. The carriage as claimed in claim 51,
said link being adjustable in length to vary the maximum displacement position of the brake arm relative to the load-supporting frame section.

54. The carriage as claimed in claim 50,
said brake including a second shiftable brake arm similar in construction and function to the first-mentioned brake arm,
said lever being operably coupled via the linkage to both of the brake arms for simultaneously moving the brake arms between the respective positions thereof.

55. The carriage as claimed in claim 54,
said first directions of shifting for the brake arms being in opposition to one another, and said second directions of shifting for the brake arms being in opposition to one another, whereby movement of the carriage is restricted as the brake arms shift from the release position to the braking position.

56. The carriage as claimed in claim 54,
said linkage permitting the brake arms to cooperatively pivot relative to the load-supporting section while in the braking position, such that the arms are configured to engage an uneven portion of the surface.

57. The carriage as claimed in claim 56,
said linkage including a rocker arm lever and a pair of links, each being pivotally connected between the rocker arm lever and a corresponding one of the brake arms at respective linkage pivot points,
said brake lever being pivotally attached to the rocker arm lever at another linkage pivot point spaced between the pivot points joining the rocker arm lever and the links,
said rocker arm lever, links, and brake arms defining a four-bar linkage that provides the cooperative pivoting of the brake arms when in the braking position.

58. The carriage as claimed in claim 57,
said brake arms pivoting about a common arm pivot point,
said lever pivot point, the arm pivot point, and said another linkage pivot point defining the at least three of said pivot points.

59. The carriage as claimed in claim 42,
said brake being shiftable between an engaged condition wherein the brake restricts carriage movement and a disengaged condition wherein carriage movement is permitted,
said brake including a shiftable brake arm shiftably attached to the load-supporting frame section for movement into and out of a braking position corresponding to the engaged condition of the brake,
said brake further including first and second brake control levers, each of which independently controls shifting of the brake arm into the braking position, wherein either control lever can be used to control engagement of the brake.

60. The carriage as claimed in claim 42,
said brake being shiftable between an engaged condition wherein the brake restricts carriage movement and a disengaged condition wherein carriage movement is permitted,
said brake including a shiftable brake arm shifted into a braking position when the brake is positioned in the engaged condition,
said brake including a brake control lever that is shifted into an engagement position when the brake arm is in the braking position,
said brake including a latch mechanism for releasably retaining the control lever in the engagement position.

61. The carriage as claimed in claim 42,
said brake including a manually operable brake control lever that is pivotally attached to the load-supporting frame section and is operable to shift the brake into and out of the engaged condition,
said brake control lever including a manually engageable surface against which a manual force is exerted to shift the lever,
said brake control lever including a pair of telescopically interfitted lever portions to permit adjustable lengthening of the brake control lever and thereby repositioning of the manually engageable surface,
said brake control lever further including a locking mechanism for selectively preventing relative telescopic shifting of the lever portions.
